(19) United States
(12) Patent Application Publication
(10) Pub. No.: US 2026/0150056 A1
(43) Pub. Date: May 28, 2026

(54) POWER CONTROL SCHEMES FOR READER DEVICES

(71) Applicant: QUALCOMM Incorporated, San Diego, CA (US)

(72) Inventors: Madhav VENKATESWARAN, Hyderabad (IN); Pranavsesh VS, Hyderabad (IN); Meenakshisundaram GURUNATHAN, Hyderabad (IN); Balasubramanian RAMACHANDRAN, Hyderabad (IN); Arvind SRIDHARAN, Bangalore (IN)

(21) Appl. No.: 18/963,182

(22) Filed: Nov. 27, 2024

(51) Int. Cl. H04W 52/02

(52) U.S. Cl. CPC H04W 52/0258

(57) ABSTRACT

In some examples of the techniques described herein, power control schemes between an interrogator mode and a tag response mode of a reader device may be separated to operate at different power amplifier bias points, which may reduce battery power consumption. In some examples, automatic power control in a physical layer may be implemented to achieve a target range at a reduced battery power consumption. In some approaches, tuning may start at a relatively high (e.g., maximum) transmit power and is gradually converged to a lower power level based on a received signal strength indicator (RSSI) through a binary search or similar procedure to determine the power level. In some of the approaches described herein, tuning may begin at a lower (e.g., median) transmit power level, and may avoid the higher transmit power scenario, which may reduce or avoid heavy battery loading.

### FIELD OF TECHNOLOGY

The following relates to wireless communications, including power control schemes for reader devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a reader device is described. The method may include transmitting a first signal during a tag response mode, where the reader device operates, during the tag response mode, in accordance with a first power control scheme that is associated with a first bias and a first compression and transmitting a second signal during a interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second power control scheme satisfies a spectral emission mask and the first power control scheme is not limited by the spectral emission mask.

A reader device is described. The reader device may include one or more transceivers, one or more memory, and one or more processors electronically coupled to the one or more memory and the one or more transceivers. The one or more processors may be configured to transmit a first signal during a tag response mode, where the reader device operates, during the tag response mode, in accordance with a first power control scheme that is associated with a first bias and a first compression and transmit a second signal during a interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second power control scheme satisfies a spectral emission mask and the first power control scheme is not limited by the spectral emission mask.

Another reader device is described. The reader device may include means for transmitting a first signal during a tag response mode, where the reader device operates, during the tag response mode, in accordance with a first power control scheme that is associated with a first bias and a first compression and means for transmitting a second signal during a interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second power control scheme satisfies a spectral emission mask and the first power control scheme is not limited by the spectral emission mask.

A non-transitory computer-readable medium storing code is described. The code may include instructions executable by one or more processors to transmit a first signal during a tag response mode, where the reader device operates, during the tag response mode, in accordance with a first power control scheme that is associated with a first bias and a first compression and transmit a second signal during a interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second power control scheme satisfies a spectral emission mask and the first power control scheme is not limited by the spectral emission mask.

In some examples of the method, reader devices, and non-transitory computer-readable medium described herein, the first power control scheme may include supplying a first voltage in accordance with the first bias that may be less than a voltage supplied in accordance with the second bias for the second power control scheme.

In some examples of the method, reader devices, and non-transitory computer-readable medium described herein, the first signal during the tag response mode may be a continuous wave signal.

In some examples of the method, reader devices, and non-transitory computer-readable medium described herein, the second signal communicated during the interrogator mode may be a modulated signal.

In some examples of the method, reader devices, and non-transitory computer-readable medium described herein, during the interrogator mode, the reader device may generate the second signal based on the second bias, and the second signal may satisfy, within a tolerance, the spectral emission mask that includes a set of power or emission limits that varies over a spectral range including a center frequency of the second signal.

Some examples of the method, reader devices, and non-transitory computer-readable medium described herein may further include operations, features, means, or instructions for measuring digital samples associated with the second signal before power amplification and transmission, where the second bias may be selected based on the measurement of the digital samples for the second signal to satisfy, within a tolerance, the spectral emission mask that includes a set of power or emission limits that varies over a spectral range including a center frequency.

Some examples of the method, reader devices, and non-transitory computer-readable medium described herein may further include operations, features, means, or instructions for measuring the second signal via a feedback receiver, where the second bias may be selected based on the measurement of the second signal for a transmission to satisfy, within a tolerance, the spectral emission mask that includes a set of a power or emission limits that varies over a spectral range including a center frequency.

A method by a reader device is described. The method may include transmitting a first signal at a power level, where the first signal is based on a first packet, and where bits corresponding to the first packet are truncated with a first truncation, determining whether a communication that is associated with the first signal having the first truncation is successful, and controlling the power level based on the determination, where the power level is increased for a second packet based on an unsuccessful communication or the power level is maintained for a second packet having the first truncation based on a successful communication.

A reader device is described. The reader device may include one or more transceivers, one or more memory, and one or more processors electronically coupled to the one or more memory and the one or more transceivers. The one or more processors may be configured to transmit a first signal at a power level, where the first signal is based on a first packet, and where bits corresponding to the first packet are truncated with a first truncation, determine whether a communication that is associated with the first signal having the first truncation is successful, and control the power level based on the determination, where the power level is increased for a second packet based on an unsuccessful communication or the power level is maintained for a second packet having the first truncation based on a successful communication.

Another reader device is described. The reader device may include means for transmitting a first signal at a power level, where the first signal is based on a first packet, and where bits corresponding to the first packet are truncated with a first truncation, means for determining whether a communication that is associated with the first signal having the first truncation is successful, and means for controlling the power level based on the determination, where the power level is increased for a second packet based on an unsuccessful communication or the power level is maintained for a second packet having the first truncation based on a successful communication.

A non-transitory computer-readable medium storing code is described. The code may include instructions executable by one or more processors to transmit a first signal at a power level, where the first signal is based on a first packet, and where bits corresponding to the first packet are truncated with a first truncation, determine whether a communication that is associated with the first signal having the first truncation is successful, and control the power level based on the determination, where the power level is increased for a second packet based on an unsuccessful communication or the power level is maintained for a second packet having the first truncation based on a successful communication.

Some examples of the method, reader devices, and non-transitory computer-readable medium described herein may further include operations, features, means, or instructions for controlling the power level includes setting the power level to a first level for a most significant bit (MSB) truncation, setting the power level to a second level for a least significant bit (LSB) truncation, or setting the power level to a third level for LSB truncation and MSB truncation.

In some examples of the method, reader devices, and non-transitory computer-readable medium described herein, the power level may be controlled by a feedback receiver based on a feedback signal that may be based on the first signal.

Some examples of the method, reader devices, and non-transitory computer-readable medium described herein may further include operations, features, means, or instructions for measuring digital samples associated with the first signal before power amplification and transmission, where the power level may be controlled by a feedback receiver based on the measurement of the digital samples for the first signal to satisfy, within a tolerance, a set of power or emission limits that varies over a spectral range including a center frequency.

Some examples of the method, reader devices, and non-transitory computer-readable medium described herein may further include operations, features, means, or instructions for adjusting a starting power level for controlling the power level based on whether the communication was successful.

Some examples of the method, reader devices, and non-transitory computer-readable medium described herein may further include operations, features, means, or instructions for transmitting a second signal during an interrogator mode, where the power level may be controlled based on the starting power level determined for a tag response mode.

Some examples of the method, reader devices, and non-transitory computer-readable medium described herein may further include operations, features, means, or instructions for determining an average power of a duty cycle of the reader device based on a statistic that may be based on the first truncation and estimating a thermal condition or usage based on the average power.

Some examples of the method, reader devices, and non-transitory computer-readable medium described herein may further include operations, features, means, or instructions for determining an average power of a duty cycle of the reader device based on a statistic that may be based on the first truncation and controlling the power level of the reader device for a period in which the reader device communicates via another radio access technology (RAT) based on the average power.

Some examples of the method, reader devices, and non-transitory computer-readable medium described herein may further include operations, features, means, or instructions for determining a specific absorption rate (SAR) value based on the power level that may be based on bit truncation, where the SAR value indicates a peak SAR or an average SAR.

Some examples of the method, reader devices, and non-transitory computer-readable medium described herein may further include operations, features, means, or instructions for obtaining one or more SAR values corresponding to one or more radio access technologies (RATs) and controlling transmit activity based on a combination of the SAR value and the one or more SAR values corresponding to the one or more RATs.

Some examples of the method, reader devices, and non-transitory computer-readable medium described herein may further include operations, features, means, or instructions for determining an estimate of temperature associated with the reader device based on the power level that may be estimated based on bit truncation, controlling a first bias power of a power amplifier for a continuous wave transmission, and controlling a second bias power of the power amplifier for a modulated wave transmission based on the estimate of temperature and the bit truncation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports power control schemes for reader devices in accordance with one or more aspects of the present disclosure.

FIG. 2 shows an example of a wireless communications system that supports power control schemes for reader devices in accordance with one or more aspects of the present disclosure.

FIG. 3 shows an example of a wireless communications system that supports power control schemes for reader devices in accordance with one or more aspects of the present disclosure.

FIG. 4 shows an example of a wireless communications system that supports power control schemes for reader devices in accordance with one or more aspects of the present disclosure.

FIG. 5 shows a flowchart illustrating an example of a method that supports power control schemes for reader devices in accordance with one or more aspects of the present disclosure.

FIG. 6 shows a block diagram of an example of a radio frequency (RF) transceiver circuit that supports power control schemes for reader devices in accordance with one or more aspects of the present disclosure.

FIG. 7 shows a flowchart illustrating an example of a method that supports power control schemes for reader devices in accordance with one or more aspects of the present disclosure.

FIG. 8 shows a flowchart illustrating an example of a method that supports power control schemes for reader devices in accordance with one or more aspects of the present disclosure.

FIGS. 9 and 10 show block diagrams of devices that support power control schemes for reader devices in accordance with one or more aspects of the present disclosure.

FIG. 11 shows a block diagram of a communications manager that supports power control schemes for reader devices in accordance with one or more aspects of the present disclosure.

FIG. 12 shows a diagram of a system including a device that supports power control schemes for reader devices in accordance with one or more aspects of the present disclosure.

FIGS. 13 through 16 show flowcharts illustrating methods that support power control schemes for reader devices in accordance with one or more aspects of the present disclosure.

### DETAILED DESCRIPTION

Some radio frequency identification (RFID) readers utilize different operation modes for pairing with passive RFID tags. In an interrogator mode (e.g., query mode), a reader device may transmit a modulated waveform (e.g., an amplitude shift keying (ASK) modulated waveform) to interrogate or query a tag device. In a tag response (e.g., non-query or receive mode), the reader device may transmit a continuous wave (CW) signal to power a tag device (e.g., passive tag). A backscattered response may be received from the tag device and demodulated. Transmitted power between the operating modes is often maintained. For instance, a power amplifier or digital-to-analog converter (DAC) bias may be maintained between the interrogator mode and tag response mode, thereby limiting power amplifier efficiency and increasing power consumption. Accordingly, the reader device may consume more power than is necessary for successful communication in the different operation modes.

In some examples of the techniques described herein, the interrogator mode and the tag response mode of reader device operations (on a mobile device, for instance), may be separated to satisfy a spectral emission mask. During interrogator mode, when the modulated (e.g., ASK) waveform may be transmitted, a relatively stringent emission mask criterion may be satisfied by the RFID reader. This may dictate the power amplifier supply voltage (e.g., Vcc) to be relatively high to provide increased power amplifier linearity to achieve a power output that can meet the spectrum emission mask criterion. In some approaches, power control schemes between the modes may be separated to operate at different power amplifier bias points, which may reduce battery power consumption.

In some examples of the techniques described, automatic power control in a physical layer may be implemented to achieve a target range at a reduced battery power consumption. In some approaches, tuning starts at a relatively high (e.g., maximum) transmit power and is gradually converged to a lower power level based on a received signal strength indicator (RSSI) through a binary search or similar procedure to determine the power level. In some of the approaches described herein, tuning may begin at a lower (e.g., median) transmit power level, and may avoid the higher transmit power scenario, which may reduce or avoid heavy battery loading.

Aspects of the disclosure are initially described in the context of wireless communications systems. Aspects of the disclosure are also described in the context of block diagrams. Aspects of the disclosure are further illustrated by and described with reference to apparatus diagrams, system diagrams, and flowcharts that relate to power control schemes for reader devices.

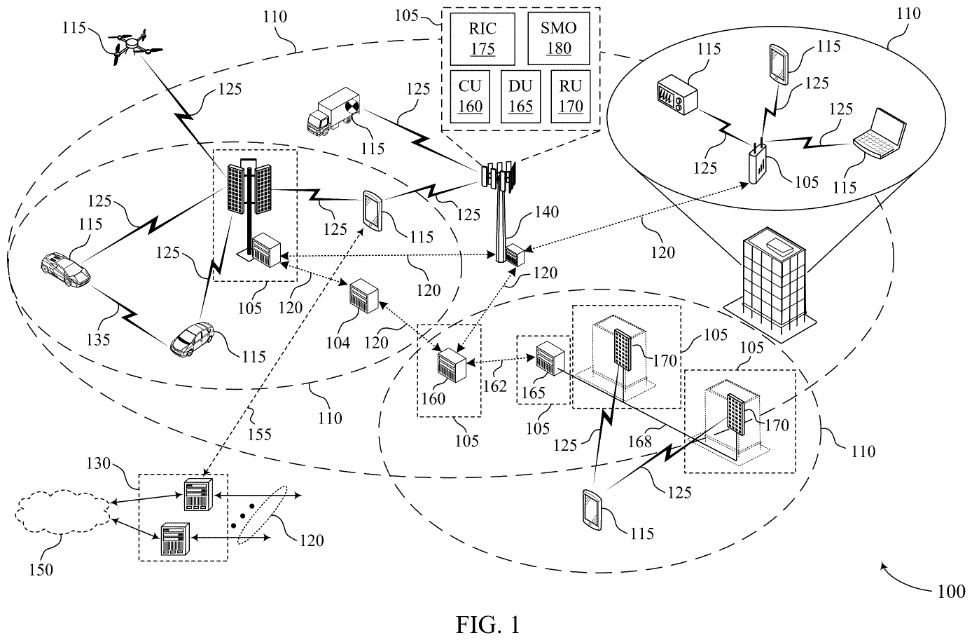

FIG. 1 shows an example of a wireless communications system 100 that supports power control schemes for reader devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support power control schemes for reader devices as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some RFID readers (e.g., UEs 115) may utilize different operation modes for pairing with passive RFID tags. In an interrogator mode (e.g., query mode), a reader device may transmit a modulated waveform (e.g., an ASK modulated waveform) to interrogate or query a tag device. In a tag response (e.g., non-query or receive mode), the reader device may transmit a CW signal to power a tag device (e.g., passive tag). A backscattered response may be received from the tag device and demodulated. Transmitted power between the operating modes is often maintained. For instance, a power amplifier or DAC bias may be maintained between the interrogator mode and tag response mode, thereby limiting power amplifier efficiency and increasing power consumption. Accordingly, the reader device may consume more power than is necessary for successful communication in the different operation modes.

In some examples of the techniques described, the interrogator mode and the tag response mode of reader device operations (on a mobile device, for instance), may be separated to satisfy a spectral emission mask. During interrogator mode, when the modulated (e.g., ASK) waveform may be transmitted, a relatively stringent emission mask criterion may be satisfied by the RFID reader. This may dictate the power amplifier supply voltage (e.g., Vcc) to be relatively high to provide increased power amplifier linearity to achieve a power output that can meet the spectrum emission mask criterion. In some approaches, power control schemes between the modes may be separated to operate at different power amplifier bias points, which may reduce battery power consumption.

In some examples of the techniques described, automatic power control in a physical layer may be implemented to achieve a target range at a reduced battery power consumption. In some approaches, tuning starts at a relatively high (e.g., maximum) transmit power and is gradually converged to a lower power level based on an RSSI through a binary search or similar procedure to determine the power level. In some of the approaches described herein, tuning may begin at a lower (e.g., median) transmit power level, and may avoid the higher transmit power scenario, which may reduce or avoid heavy battery loading.

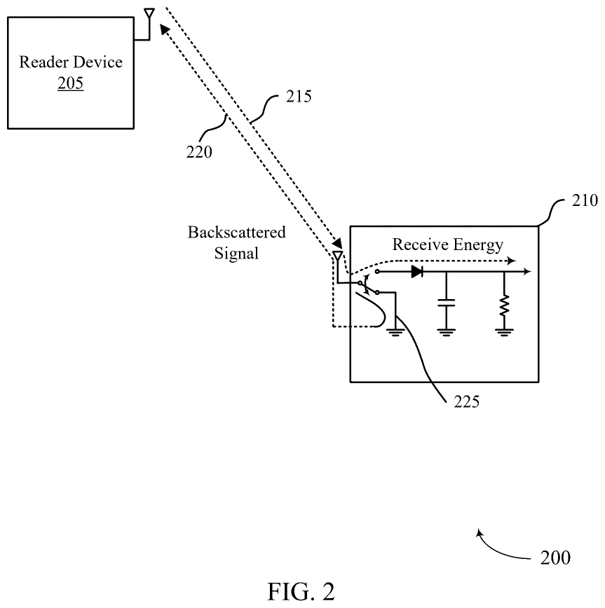

FIG. 2 shows an example of a wireless communications system 200 that supports power control schemes for reader devices in accordance with one or more aspects of the present disclosure. The wireless communications system 200 may implement aspects of the wireless communications system 100. The wireless communications system 200 may include a reader device 205, which may be an example of a UE 115 or a network entity 105 as described herein. The reader device 205 may also be referred to as a wireless communication device. In some aspects, the reader device 205 may be an example of an energy transfer device or an RFID reader.

The wireless communications system 200 may include a tag device 210. In some examples, the tag device 210 may be a UE 115 as described herein. The tag device 210 may be capable of performing backscattering based communication. In some examples, the tag device 210 may be an example of an IoT device, an ambient IoT device, an RFID tag, or any combination thereof. In some examples, the tag device 210 may be referred to as an energy harvesting (EH)-capable device. The tag device 210 (e.g., EH-capable device) may harvest energy over the air (e.g., via reception of an interrogating signal 215) and power transmission/reception circuitry 225 via using the energy of the interrogating signal 215 to transmit a responsive signal 220 to the interrogating signal 215. Responsive signals 220 transmitted by RFID devices may be backscatter modulated (e.g., referred to as backscatter responses). In some examples, RFID devices may be semi-passive or active and may include an energy storage device (e.g., a battery). In some examples, a wireless communications system may support a bistatic structure, where one network device (e.g., the reader device 205) transmits an energy transfer signal (e.g., the interrogating signal 215) to the tag device 210 and another network device may receive the responsive signal 220 (e.g., may communicate with the tag device 210).

Tag devices (e.g., tag device 210) may be passive, semi-passive, or active. Table (1) below shows examples of characteristics of passive, semi-passive, and active tag devices. Example applications for passive tag devices may include access or proximity cards. Example applications for semi-passive EH-capable devices may include electronic tolls or pallet tracking. Example applications for active EH-capable devices may include large asset tracking or livestock tracking.

TABLE 1

| | | | |
|---|---|---|---|
| EH-Capable | Passive | Semi-Passive | Active |
| Device Type | | | |
| Power Source | Harvesting | Harvesting | Harvesting |
| | energy (e.g., | energy (e.g., | energy (e.g., |
| | RF energy, | RF energy, | RF energy, |
| | solar, heat) | solar, heat), | solar, heat), |
| | | battery | battery |
| Communication | Response only | Response only | Respond or |
| type | | | initiate |
| Approximate | 10M | >100M | >100M |
| Maximum Range | | | |
| Relative Cost | Least expensive | More expensive | Most expensive |

Passive tag devices may have short range capability (e.g., less than 10 meters) due to insufficient link budget issues and poor communication reliability. For example, the maximum transmit power by the reader device 205 may be limited for the transmission band. For example, the effective isotropic radiated power (EIRP) for the network device may be 36 decibel-milliwatts (dBm). As another example, weak reflected backscatter signal by passive tag devices may limit the range of the passive tag devices. As passive tag devices are power limited, the reflected signal power strength is approximately inversely proportional to the fourth power of the distance

$$\frac{1}{{d}^{4}} .$$

Another issue affecting the range of passive tag devices may be interference from other reader devices, other tags, or other communications systems. Cyclic redundancy check (CRC) may be used for error detection for signals involving passive tag devices.

In some examples, a passive RFID system may include an RFID reader, which may be an example of a reader device 205. The RFID reader may include a baseband processor, a transmitter, a receiver, a circulator, or one or more antennas. An example of a procedure for data exchange between the RFID reader and an RFID tag is given as follows. The RFID reader may transmit power (e.g., power and data) to an RFID tag, which may be an example of a tag device 210. During an interrogator mode, the RFID reader may transmit (e.g., output) a modulated interrogation or query signal. During a tag response mode, the RFID reader may transmit a continuous wave waveform. The RFID tag may include an integrated circuit (e.g., chip), a switch, or an antenna. During the tag response mode, the RFID tag may transmit a modulated backscatter signal in response to the power (e.g., power and data) provided by the RFID reader. The backscatter signal may indicate data, which may be received by the RFID reader.

As described herein, ambient IoT devices such as the tag device 210 may be used for inventory use cases in indoor or outdoor environments. For example, Table (2) shows different example use cases for indoor ambient IoT devices and parameters associated with the use cases. Table (3) shows different example use cases for outdoor ambient IoT devices and parameters associated with the use cases. Table (2) or Table (3) illustrate examples of uses cases, message size (in bits), report data, a reporting period (for Table (2)), latency (in seconds), positioning accuracy (in meters at 90%), device density (/100 meters squared), and moving speed (in kilometers (km) per hour (hr)). For convenience, the term “management” is abbreviated as “mgmt.” in Table (2) and Table (3).

TABLE (2)

| | | | | | Position | Device | |
|---|---|---|---|---|---|---|---|
| | | | Report | | Accuracy | Density | |
| | Size | Report | period | Latency | (m at | (/100 | Speed |
| Use Case | (bits) | Data | (min) | (s) | 90%) | m²) | (km/hr) |
| Automated | 96/128 | Device | — | 1 | 2-3 | — | 5-10 |
| warehousing | | ID or | | | | | |
| Medical | 176 | position | — | Several | 3-5 | ≥0.1 | <6 |
| instruments | | | | seconds | | | |
| inventory | | | | | | | |
| mgmt. and | | | | | | | |
| positioning | | | | | | | |
| Non-Public | — | | — | — | — | — | — |
| Network for | | | | | | | |
| logistics | | | | | | | |
| Automobile | 96 | | — | >0.1 (>100 | 3 | <150 | — |
| manufacturing | | | | tags/s) | | | |
| Airport | 256 | | — | 1-10 | Cell | 0.01 | 3-10 |
| terminal/ | | | | | level | | |
| shipping port | | | | | | | |
| Smart laundry | <800 | | — | >10 | — | 20 | ≤6 |
| Automated | <800 | | — | >10 | Indoor: 3 | <150 | — |
| supply chain | | | | | Outdoor: | | |
| distribution | | | | | cell level | | |
| Fresh food | <100 | | 15 | >60 | — | 150 | 3.6 |
| supply chain | | | | | | | |
| End-to-end | — | | — | — | — | — | — |
| logistics | | | | | | | |
| Flower | 96 | | — | 10 | — | <130 | — |
| auction | | | | | | | |
| Electronic | 96 | | | | | | |
| shelf label | | | | | | | |

TABLE (3)

| | | | | Position | Device | |
|---|---|---|---|---|---|---|
| | Message | | | Accuracy | Density | Moving |
| | Size | Report | Latency | (m at | (/100 | speed |
| Use Case | (bits) | Data | (s) | 90%) | m²) | (km/hr) |
| Medical | 176 | Device ID/ | Several | 3-5 | >0.1 | <6 |
| instruments | | position | seconds | | | |
| inventory | | | | | | |
| mgmt. and | | | | | | |
| positioning | | | | | | |
| Non-Public | — | | — | — | — | — |
| Network for | | | | | | |
| logistics | | | | | | |
| Airport | 256 | | 1-10 | Cell level | 0.01 | 3-10 |
| terminal/ | | | | | | |
| shipping | | | | | | |
| port | | | | | | |
| Automated | <800 | | >10 | Indoor: 3 | — | — |
| supply | | | | Outdoor: | | |
| chain | | | | cell level | | |
| distribution | | | | | | |

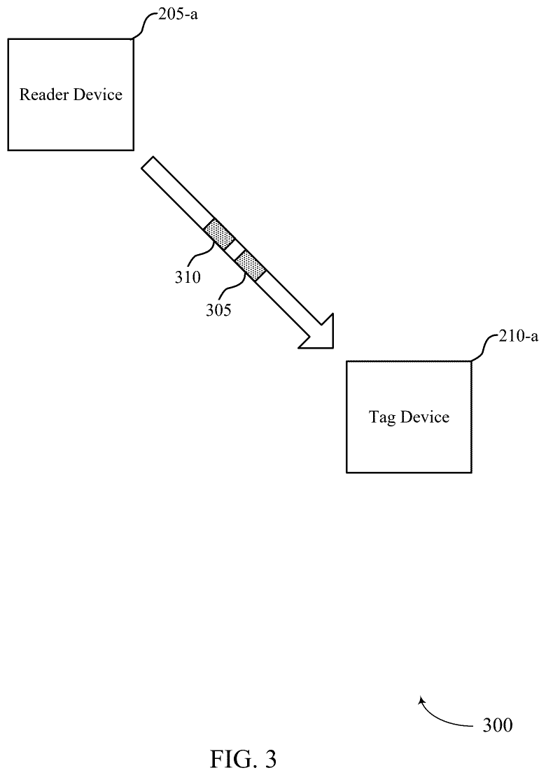

In some examples, the reader device 205 may be implemented with one or more of the structures, or may be implemented to perform one or more of the operations described with reference to one or more of FIGS. 3-8. Additionally, or alternatively, the tag device 210 may be implemented with one or more of the structures, or may be implemented to perform one or more of the operations described with reference to one or more of FIGS. 3-8.

FIG. 3 shows an example of a wireless communications system 300 that supports power control schemes for reader devices in accordance with one or more aspects of the present disclosure. The wireless communications system 300 may implement aspects of the wireless communications system 100 or the wireless communications system 200. For example, the wireless communications system 300 includes a reader device 205-a, which may be an example of a reader device 205 as described herein. In some cases, the reader device 205-a may be (or may be referred to) as a wireless device, UE, or other device. The wireless communications system 300 may include a tag device 210-a, which may be an example of the tag device 210 as described with reference to FIG. 2. The tag device 210-a may be an EH-capable device.

As described herein, the reader device 205-a may operate in an interrogator mode or a tag response mode. During the interrogator mode, the reader device 205-a may transmit (e.g., output) a modulated interrogation or query signal. During the tag response mode, the reader device 205-a may transmit a continuous wave waveform. During the tag response mode, the tag device 210-a may transmit a modulated backscatter signal, or may perform another operation (e.g., with or without transmitting a backscatter signal) in response to the power (e.g., power and data) provided by the reader device 205-a.

The reader device 205-a may transmit a first signal 305 during a tag response mode. For instance, the first signal 305 during the tag response mode may be a continuous wave signal (e.g., a wave, such as a sine wave, with a relatively constant amplitude or frequency).

The reader device 205-a may operate, during the tag response mode, in accordance with a first power control scheme. A power control scheme may be, or may include, one or more operations that relate to power consumption. For instance, a power control scheme may include one or more operations for supplying power to one or more circuit components (e.g., a power amplifier) or for controlling transmission power.

In some examples, the first power control scheme may be associated with a first bias or a first compression. A bias may refer to an amount of voltage (e.g., “Vcc”) or current (e.g., “Icq”) provided to a power amplifier. For instance, Vcc may refer to a supply voltage for circuitry (e.g., for a power amplifier). Icq may refer to a current (e.g., a collector current associated with the bias). A compression may refer to power amplifier performance. For instance, when a power amplifier is driven with a greater amount of voltage (e.g., a higher Vcc) or a greater amount of current (e.g., Icq) for less compression, the power amplifier may perform with a higher degree of linearity and greater power consumption while amplifying an input signal. When a power amplifier is driven with a lesser amount of voltage (e.g., a lower Vcc) or a lesser amount of current (e.g., Icq) for higher compression, the power amplifier may perform with a lower degree of linearity and less power consumption while amplifying an input signal.

The reader device 205-a may transmit a second signal 310 during an interrogator mode. For instance, the second signal 310 communicated during the interrogator mode may be a modulated signal (e.g., an ASK modulated signal, among other examples).

The reader device 205-a may operate, during the interrogator mode, in accordance with a second power control scheme. The second power control scheme may be associated with a second bias or a second compression. The first bias of the first power control scheme may be lower than the second bias of the second power control scheme. Additionally, or alternatively, the first compression of the first power control scheme may be higher than the second compression of the second power control scheme. In some approaches, the second power control scheme may satisfy a spectral emission mask or the first power control scheme may not be limited by the spectral emission mask (e.g., any spectral emission mask). For instance, the second power control scheme may satisfy a spectral emission mask by controlling or maintaining a power or emission of the reader device 205-a to be within (e.g., below) one or more limits of the spectral emission mask. In some aspects, the second power control scheme may satisfy (e.g., meet) a relatively tight spectral emission mask to meet regulatory compliance. Additionally, or alternatively, the first power control scheme, by design, may not be limited by (e.g., may not violate) any spectral emission mask.

In some examples, the first power control scheme may include supplying a first voltage in accordance with the first bias that is less than a voltage supplied in accordance with the second bias for the second power control scheme. During the tag response mode, for instance, the reader device 205-a may reduce the power amplifier voltage (e.g., Vcc) or may operate the power amplifier with greater (e.g., “deep”) compression to improve efficiency and reduce power consumption (e.g., achieve power savings).

In tag response mode (e.g., non-query mode), the reader device 205-a may transmit or send a continuous wave signal (e.g., only a continuous wave signal) to power the tag device 210-a. Because the reader device 205-a may output a continuous wave signal transmission during the tag response mode, the power amplifier of the reader device 205-a may be operated at a lower bias point. For instance, In the tag response mode, a continuous wave tone may be transmitted that may be a relatively narrow tone that may not violate the spectral emission mask. The bias point may be controlled to reduce power consumption (e.g., minimize battery power consumption). Because a continuous wave tone is transmitted, for example, transmission emission limits may be relaxed in the tag response mode or a power amplifier or DAC biasing scheme (e.g., with a reduced Vcc or Icq) may achieve improved efficiency during the tag response mode.

During the interrogator mode (e.g., query mode), the reader device 205-a may operate the power amplifier with a higher voltage or current (e.g., higher Vcc or Icq) or with less compression (e.g., mild or no compression). During the interrogator mode, for example, the reader device 205-a may generate the second signal 310 based on the second bias (e.g., higher Vcc or Icq). The second signal 310 may satisfy (e.g., within a tolerance, such as within +1%, 3%, 5%, or 10% of a power limit, among other examples) a set of one or more power or emission limits that varies over a spectral range including a center frequency of the second signal 310. In some examples, the set of power or emissions limits that varies over a spectral range may be (e.g., may be included in) a spectral emission mask. For instance, the spectral emission mask may be a spectral emission mask in accordance with Electronic Product Code (EPC) specifications (e.g., an EPC RF Identity Protocols Generation-2 UHF RFID specification). In interrogator mode, for instance, an ASK waveform may be transmitted that meets a spectral emission mask. For instance, a bias point may be determined or utilized to keep power amplifier noise below the spectral emission mask.

In some approaches, the reader device 205-a may operate the power amplifier with an increased power or current to satisfy (e.g., to keep spectral emissions within) an EPC spectral emission mask. For instance, EPC RFID specifications may define a spectral emission mask that may be applied in interrogator mode (e.g., during at least a portion of time in interrogator mode). In one example, a transmit mask for multiple-interrogator environments (e.g., when there are one or more reader devices present or within a distance from the reader device 205-a). The spectral emission mask may include multiple power levels that vary over frequency (e.g., centered on a center frequency of transmission, fc). At the center frequency, the spectral emission mask may allow up to 0 dB power. At ±1 channel (e.g., 1 channel bandwidth), up to −20 dB power may be allowed. At ±2 channels, up to −50 dB power may be allowed. At ±3 channels, up to −60 dB power may be allowed. At ±4 channels, up to −65 dB power may be allowed. In another example, a transmit mask for dense-interrogator environments (e.g., when a density condition of reader devices is satisfied). The spectral emission mask may include multiple power levels that vary over frequency (e.g., centered on a center frequency of transmission, fc). At the center frequency, the spectral emission mask may allow up to 0 dB power (e.g., within ±1.25/Tari). Tari may be a waveform parameter that corresponds to a duration of a data bit 0 in a data packet (e.g., that may include one or more 0s or 1s), where the data packet may be transmitted in conformance with a protocol for RFID. In a range from 1.25/Tari to 3.75/Tari, or in a range from −1.25/Tari to −3.75/Tari, up to −30 dB power may be allowed. In a range from 3.75/Tari to 6.25/Tari, or in a range from −3.75/Tari to −6.25/Tari, up to −60 dB power may be allowed. In a range from 6.25/Tari to 8.75/Tari, or in a range from −6.25/Tari to −8.75/Tari, up to −65 dB power may be allowed.

In some approaches, to further reduce an impact to power consumption (e.g., battery power) in the interrogator mode (e.g., apart from the tag response mode), the reader device 205-a may utilize a characterization of a bias (e.g., approximately a lowest bias point) that satisfies the power level(s) (e.g., spectral emission mask or EPC mask) for a given transmit power. For instance, the characterization may characterize reader device 205-a operation for one or more transmit powers (e.g., a range of transmit powers) that satisfies a spectral emission mask with a reduced tolerance (e.g., within a tolerance, such as within ±0.3%, 0.5%, 1%, 3%, or 5%, among other examples, of one or more power limits of a spectral emission mask). In some approaches, the characterization may be determined or established offline. For instance, the characterization may be based on one or more power measurements of the reader device 205-a or another device with one or more biases, where a lowest bias (or a bias within a range of the lowest bias) that satisfies the spectral emissions mask may be determined. The reader device 205-a may utilize the characterization during operation (e.g., runtime) to select a bias for use during the interrogator mode.

In some examples, one or more constraints may be addressed for implementations where the reader device 205-a is a cellular phone-based (e.g., smartphone-based) RFID reader. For example, the usage of the power amplifier (e.g., design) may not be exclusive to an RFID use. The power amplifier may be repurposed from cellular power amplifier uses, with a target to reduce battery loading while meeting one or more spectral emissions criteria (e.g., a spectral emissions mask). Some of the techniques described herein may address the constraint(s) described. For example, thermal and reliability concerns of the power amplifier may be significant factors, especially for 100 millisecond (ms) continuous operation approaches from RFID specifications. Operating at a dynamic or optimized bias point in different modes (e.g., in the interrogator mode and the tag response mode) may help to address one or more of the constraints. In some approaches, a lower bias point for the tag response mode may be selected based on a tradeoff between power consumption reduction (e.g., mobile phone battery savings), spectral emissions, or thermal management.

In some examples, the reader device 205-a may measure one or more digital samples associated with the second signal 310 before power amplification or transmission. The reader device 205-a may select the second bias based on the measurement of the digital samples for the second signal 310 to satisfy (e.g., within a tolerance, such as within ±1%, 3%, 5%, or 10% of a power limit, among other examples) a set of one or more power or emission limits that varies over a spectral range including a center frequency (e.g., a spectral emission mask that includes a set of one or more power or emission limits that varies over a spectral range including a center frequency). For instance, the reader device 205-a may have a capability to measure digital transmission samples prior to transmission (e.g., for one or more transmission packets by capturing or measuring one or more reference packets). The reader device 205-a may identify or determine when a margin (e.g., a sufficiently high margin or a threshold margin) exists to satisfy a spectral emission mask at the digital waveform level such that more RF (e.g., power amplifier) nonlinearity may be tolerated. If the margin (e.g., threshold margin) exists, the bias may be reduced, which may conserve power (e.g., save mobile phone battery).

In some examples, the reader device 205-a may measure the second signal 310 via a feedback receiver. The reader device 205-a may select the second bias based on the measurement of the second signal 310 for a transmission to satisfy (e.g., within a tolerance, such as within ±1%, 3%, 5%, or 10% of a power limit, among other examples) a set of one or more power or emission limits that varies over a spectral range including a center frequency (e.g., a spectral emissions mask that includes or corresponds to one or more power or emission limits that varies or vary over the spectral range including the center frequency). For instance, the reader device 205-a may include a feedback receiver that is associated with (e.g., coupled with) a transmitter. The reader device 205-a may measure the interrogator mode waveform using the feedback receiver in online mode. For instance, a continuous wave transmission may be routed to the feedback receiver (e.g., in a manner similar to a self-test mode). At some powers (e.g., higher transmit powers), the reader devices 205-a may not be limited by signal-to-noise ratio (SNR) and accordingly may measure (e.g., more accurately measure) a spectral emissions mask that is satisfied. Based on the measurement, the reader device 205-a may adjust the biasing in interrogator mode to reduce power consumption (e.g., to achieve a lower or lowest battery power consumption while satisfying an EPC emission mask).

In some examples, the reader device 205-a may transmit a first signal 305 at a power level. The first signal 305 may be based on a first packet, and bits corresponding to the first packet may be truncated with a first truncation. For instance, the reader device 205-a may include a feedback receiver or feedback receiver front end. In some aspects, the feedback receiver front end (after an analog-to-digital converter (ADC) or digital filtering or down-conversion stages, for instance) may perform bit arithmetic by detecting or determining to dynamically truncate a quantity of most significant bit (MSB) bits utilized for firmware processing. The truncation may reduce (e.g., minimize power or area) for performing one or more subsequent computations.

An example with a 32-bit register is provided as follows. For a relatively higher transmit power, the reader device 205-a may reduce a bit resolution by selecting a quantity of MSBs (e.g., only the most significant 16 bits) for further bit arithmetic. For instance, the bits may be truncated from the MSBs (e.g., the truncated bits may be 16-maximum). For a relatively lower transmit power, the reader device may select a quantity of least significant bits (LSBs) (e.g., 16 LSBs) for performing bit arithmetic (e.g., the truncated bits may be 0—minimum).

The reader device 205-a may determine whether a communication that is associated with the first signal 305 with the first truncation is successful. In some aspects, the reader device 205-a may determine whether a communication is successful based on detecting energy at a backscatter link frequency (BLF) offset (from a center frequency of the transmitted signal, for example). For instance, the reader device 205-a may detect the presence of energy at a BLF offset (e.g., with or without demodulation of the signal to compute a RSSI).

The reader device 205-a may control the power level based on the determination. The power level may be increased for a second packet (e.g., the second signal 310) based on an unsuccessful communication, or the power level may be maintained for a second packet (e.g., the second signal 310) with the first truncation based on a successful communication. In some approaches, the reader device 205-a may begin transmitting at a relatively low continuous wave transmit power level (e.g., median power), and may ramp up gradually while monitoring bit truncation. For a closer distance between the reader device 205-a and the tag device 210-a, a response from the tag device 210-a may be received at a lower power level (e.g., with truncation bit=0), and the reader device 205-a may detect a successful communication (e.g., forward link). In some relatively high continuous wave power scenarios, some bit truncation (e.g., with truncation bit=0) may not be utilized or exercised.

In some approaches, controlling the power level may include setting the power level to a first level for an MSB truncation, setting the power level to a second level for an LSB truncation, or setting the power level to a third level for LSB truncation and MSB truncation. In some approaches, the first level for the MSB truncation may be greater than the second level for the LSB truncation. In some aspects, the third level for LSB truncation and MSB truncation may be less than the first level or greater than the second level. For instance, a feedback receiver gain state may be controlled with a gain or noise figure setting. The feedback receiver gain state may be selected based on a bit truncation of a previous packet. If relatively larger quantities of MSBs are being truncated, the feedback receiver gain state may be transitioned to a higher gain (e.g., lower noise figure) to increase sensitivity. If no MSB truncation is occurring (e.g., if 8 LSB truncation is occurring), the feedback receiver gain state may be transitioned to a lower gain (e.g., higher noise figure) to help avoid ADC saturation.

In some examples, the power level may be controlled by a feedback receiver based on a feedback signal that is based on the first signal 305. In some approaches, for example, a feedback receiver may not have an automatic gain control loop (e.g., distinct from other receivers that may have automatic gain control loops). An automatic gain control loop may be implemented with tuning, and may reduce time or memory resources available for processing. RFID applications in some scenarios may involve reading a relatively large quantity of tag devices in a relatively short amount of time, for which there may not be sufficient time for loop settling for some automatic gain control loops.

A significant component of an RFID signal may be a reflected self-transmission leakage, and not be a received signal through the antenna. Receiver saturation may occur due to self-transmission leakage. Digital bit truncation may be an indicator of ADC saturation, or may be performed to reduce power consumption by reducing a quantity of bits in bit arithmetic. In some approaches, a feedback receiver gain state (e.g., analog gain state) may be set based on a quantity of MSBs being truncated. For example, if a relatively larger quantity of MSBs is being truncated (e.g., 6 dB per MSB), the reader device 205-a may transition to a higher gain (e.g., lower noise figure) to improve sensitivity. If no MSB truncation is occurring (e.g., if 8 LSB truncation is occurring), the reader device 205-a may transition to a lower gain (e.g., higher noise figure) to help avoid ADC saturation.

In some examples, the reader device 205-a may measure digital samples associated with the first signal 305 before power amplification and transmission. The power level may be controlled by a feedback receiver based on the measurement of the digital samples for the first signal 305 to satisfy, within a tolerance, a set of one or more power or emission limits that varies over a spectral range including a center frequency (e.g., a spectral emissions mask that includes or corresponds to the set of power or emission limits that varies over the spectral range including the center frequency).

In some examples, the reader device 205-a may adjust a starting power level for controlling the power level based on whether the communication was successful. For instance, by monitoring a median power to achieve a successful communication link (e.g., the truncation bit value at which communication is established), the reader device 205-a may adjust the starting transmit power based on a tradeoff between latency and power consumption. For instance, the reader device 205-a may determine a starting transmit power that may be more likely to reduce settling time (to find the truncation bit), to reduce power consumption (e.g., to minimize battery power consumption), or to achieve a balance thereof.

In some examples, the reader device 205-a may transmit a second signal 310 during an interrogator mode. The power level may be controlled based on the starting power level determined for a tag response mode. For instance, after the starting power level is determined, the reader device 205-a may map a corresponding power level to operate in for the interrogator mode, or may adjust the transmit power or power amplifier bias for power savings in interrogator mode (e.g., for transmitting an ASK waveform, where the power amplifier may be operated in mild compression, due to spectral emissions limits).

In some aspects, by logging statistics of the truncation bit value over time, the reader device 205-a may determine a duty cycle at which the power amplifier has been operating. In some approaches, the reader device 205-a may determine an average power of a duty cycle (e.g., average duty cycled power) of the reader device 205-a based on a statistic that is based on the truncation. Determining the duty cycle or average power may be utilized for estimating a power criterion (e.g., power consumption, power demand, or power limit, among other examples) for a particular tag, or for estimating the potential for managing coexistence scenarios with other radio access technologies (e.g., global navigation satellite system (GNSS), cellular, wireless local area network (WLAN), personal area network (PAN), among other examples).

In some approaches, the reader device 205-a may determine an average power of a duty cycle of the reader device 205-a (e.g., power amplifier) based on a statistic that is based on the first truncation. The reader device 205-a may estimate a thermal condition or usage based on the average power. A thermal condition may be a temperature or another quantity related to heat. A usage (e.g., usage profile) may be a quantity of power consumption (e.g., power consumed by the reader device 205-a or one or more components of the reader device 205-a). In some aspects, an average duty cycled power may be a useful metric for thermal considerations or a usage profile, among other examples. A duty cycle may indicate periods of time in which power is at an upper level or lower level (e.g., on or off).

In some examples, the reader device 205-a may determine an average power of a duty cycle of the reader device 205-a based on a statistic that is based on the first truncation. The reader device 205-a may control the power level of the reader device 205-a for a period in which the reader device 205-a communicates via another RAT based on the average power.

In some examples, the reader device 205-a may determine a specific absorption rate (SAR) value based on the power level (e.g., the power level that may be estimated based on bit truncation). The SAR value may indicate a peak SAR or an average SAR, for instance. In some aspects, the reader device 205-a may obtain one or SAR values corresponding to one or more RATs. The reader device 205-a may control transmit activity based on a combination of the SAR value and the one or more SAR values corresponding to the one or more RATs.

In some examples, the reader device 205-a may determine an estimate of temperature associated with the reader device 205-a based on the power level (e.g., that is estimated based on bit truncation). The reader device 205-a may control a first bias power of a power amplifier for a continuous wave transmission (e.g., a bias power utilized by the reader device 205-a or circuitry for a continuous wave transmission). The reader device 205-a may control a second bias power of the power amplifier for a modulated wave transmission based on the estimate of temperature and the bit truncation (e.g., a bias power utilized by the reader device 205-a or circuitry for a modulated wave transmission).

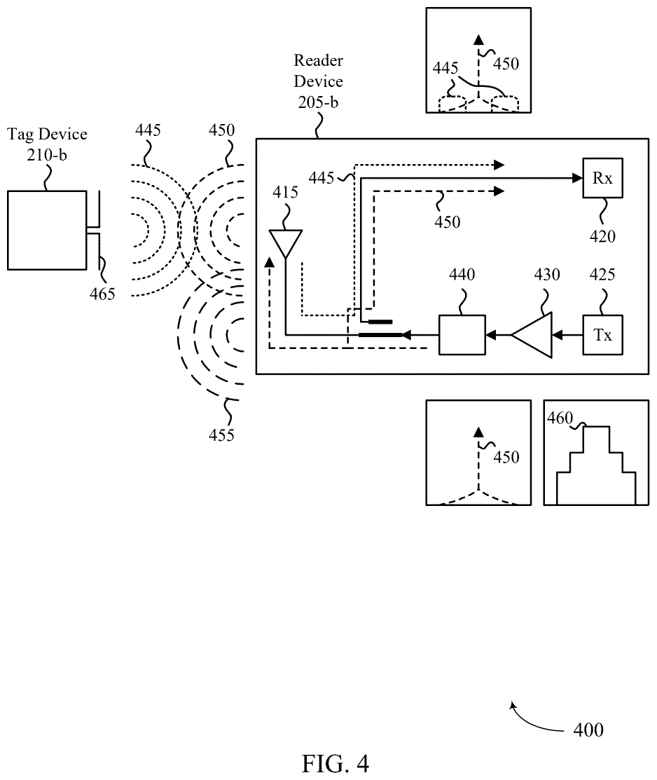

FIG. 4 shows an example of a wireless communications system 400 that supports power control schemes for reader devices in accordance with one or more aspects of the present disclosure. In the example of FIG. 4, the wireless communications system 400 includes a reader device 205-b and a tag device 210-b. The reader device 205-b may be an example of a UE 115 described with reference to FIG. 1, the reader device 205 described with reference to FIG. 2, or the reader device 205-a described with reference to FIG. 3. For instance, the reader device 205-b may perform one or more of the operations performed by the reader device 205 or the reader device 205-a, or may include one or more of the components of the reader device 205 or the reader device 205-a. Additionally, or alternatively, the reader device 205 or the reader device 205-a may perform one or more of the operations or may include one or more of the components of the reader device 205-b.

The tag device 210-b may be an example of a UE 115 described with reference to FIG. 1, the tag device 210 described with reference to FIG. 2, or the tag device 210-a described with reference to FIG. 3. For instance, the tag device 210-b may perform one or more of the operations performed by the tag device 210 or the tag device 210-a, or may include one or more of the components of the tag device 210 or the tag device 210-a. Additionally, or alternatively, the tag device 210 or the tag device 210-a may perform one or more of the operations or may include one or more of the components of the tag device 210-b. For example, the tag device 210-b may include circuitry and an antenna 465 for harvesting RF energy or performing a tag response (e.g., transmitting a backscattered signal 445).

The reader device 205-b may include receive circuitry 420, transmit circuitry 425, a power amplifier 430, a filter 440, or an antenna 415. In the example of FIG. 4, the receive circuitry 420 is illustrated as a feedback receiver. With a feedback receiver, one or more antennas (e.g., antenna 415) may be shared for transmission and reception. For instance, a software-defined ratio (SDR) path (e.g., for LTE) may be paired with a power amplifier for another technology (e.g., a power amplifier for Global System for Mobile Communications (GSM)) for RFID reader applications. In some examples, a feedback receiver may share a phase-locked loop (PLL) with the transmit circuitry (e.g., transmit circuitry 425). By sharing a PLL, phase noise from transmit leakage may be correlated with the receive PLL, which may allow for reduction (e.g., cancelation) of the phase noise at the receiver (e.g., receive circuitry 420). For instance, utilizing an on-chip feedback receiver as an RFID receiver with the same transmit local oscillator (LO) for both query and non-query modes of operation may help to handle close-in offset phase noise of the LO. A feedback receiver (e.g., receive circuitry 420) input may have a filter (e.g., the filter 440, which may be a low pass filter, a bandpass filter, or other filter). The filter may support a range of frequencies for RFID applications in different areas (e.g., different geographies or jurisdictions). While the reader device 205-b is illustrated with a feedback receiver in FIG. 4, one or more of the techniques described herein may also be applied for some reader devices that have receivers (e.g., non-feedback receivers) that are separate from the transmit circuitry (e.g., that do not share a PLL).

As illustrated in FIG. 4, the transmit circuitry 425 may produce a transmit signal 455 during interrogator mode or a transmit signal 450 during tag response mode. The transmit signal 455 or the transmit signal 450 may be radiated from the antenna 415. The reader device 205-b may alternate between interrogator mode and tag response mode. During interrogator mode, the transmit signal 455 may be a modulated waveform (e.g., ASK modulated waveform or other waveform), and a bias (e.g., bias point at moderate compression) of the power amplifier 430 may be selected to satisfy (e.g., to not exceed) a spectral emission mask 460.

During tag response mode, the transmit signal 450 may be a continuous wave signal, and a bias (e.g., bias point at heavy compression) of the power amplifier 430 may be selected to reduce (e.g., minimize) power consumption (e.g., battery power consumption). For instance, it may be possible to save 400 milliwatts (mW) in an active transmit slot by reducing the bias of the power amplifier 430. In some examples, the transmit signal 450 (e.g., continuous wave signal) during the tag response mode may be relatively narrow in frequency, which may allow a lower bias to be selected without violating the spectral emission mask 460. In some examples, a portion of the transmit signal 450 may reflect back to the receive circuitry 420.

The tag device 210-b may radiate (e.g., transmit) the backscatter signal 445 during tag response mode. As illustrated in FIG. 4, the backscatter signal 445 may be offset from the center frequency of the transmit signal 450 by a BLF offset. A BLF offset may be an offset between transmit and receive frequencies that help to separate the two waveforms. In some examples, a BLF offset may be less than or equal to 640 kilohertz (kHz).

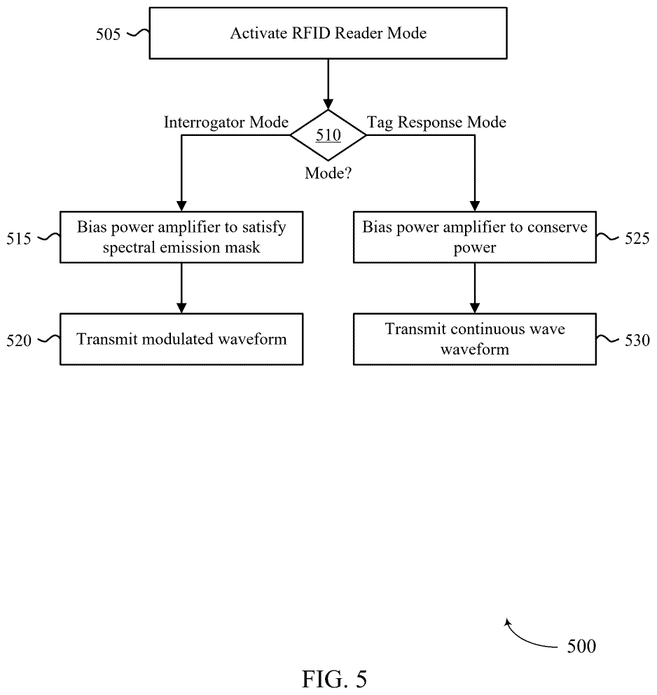

FIG. 5 shows a flowchart illustrating a method 500 that supports power control schemes for reader devices in accordance with one or more aspects of the present disclosure. The operations of the method 500 may be implemented by a reader device or its components as described herein. For example, the operations of the method 500 may be performed by a reader device as described with reference to one or more of FIGS. 2-4. In some examples, a reader device may execute a set of instructions to control the functional elements of the reader device to perform the described functions. Additionally, or alternatively, the reader device may perform aspects of the described functions using special-purpose hardware.

In some examples, one or more operations of the method 500 may be omitted, or one or more operations may be added to the method 500. For instance, one or more of the operations described herein may be combined with the method 500. Additionally, or alternatively, one or more of the operations described in the method 500 may be performed in the order shown, or in a different order. In some aspects, multiple operations of the method 500 may be performed in overlapping time frames (e.g., may be combed or performed in parallel). Additionally, or alternatively, one or more of the operations of the method 500 may be divided into multiple operations.

At 505, the method may include activating an RFID reader mode. For instance, a smartphone may activate RFID reader mode based on a received interface (e.g., user interface) input, a received signal, or another triggering event.

At 510, the method may include determining whether the reader device is in interrogator mode or tag response mode. For instance, while in reader mode, the reader device may periodically alternate between interrogator mode (e.g., where a modulated waveform is transmitted) and tag response mode (e.g., where a continuous wave waveform is transmitted or a backscatter signal is received) as described with reference to one or more of FIGS. 2-4.

If the reader device is in interrogator mode, the method may include biasing a power amplifier to satisfy a spectral emission mask at 515. For instance, during interrogator mode operation, the reader device may bias the power amplifier relatively conservatively (e.g., with a higher Vcc or Icq) to satisfy an RFID spectral emission mask as described with reference to one or more of FIGS. 2-4.

At 520, the method may include transmitting a modulated waveform. For instance, the reader device may transmit an ASK modulated waveform during the interrogator mode as described with reference to one or more of FIGS. 2-4.

The method may include biasing a power amplifier to conserve power at 525 if the reader device is in tag response mode. For instance, during tag response mode operation, the reader device may bias the power amplifier relatively aggressively (e.g., with a lower Vcc or Icq) to reduce (e.g., optimize) power consumption as described with reference to one or more of FIGS. 2-4.

At 530, the method may include transmitting a continuous wave waveform. For instance, the reader device may transmit a continuous wave waveform during the tag response mode (as the RFID spectral emission mask may not be applicable, for example) as described with reference to one or more of FIGS. 2-4.

In other approaches, a reader device may be put in RFID reader mode. A tag device may be queried to establish a link using an ASK modulated waveform. A power amplifier bias point and compression may be determined to satisfy the RFID spectral emissions mask for a target range. The reader device may transition to a tag response mode and transmit a continuous wave tone. In some examples, a power amplifier may be biased at maximum power or at a high enough power to achieve the target range. In some of these approaches, the power compression point may be equivalent to the bias point to satisfy emissions in the interrogator mode (e.g., with mild compression). The RFID reader may alternate between the interrogator and tag response mode, with a power amplifier bias maintained (e.g., kept at a same or similar bias) between the two modes, which may waste energy during the tag response mode, for instance.

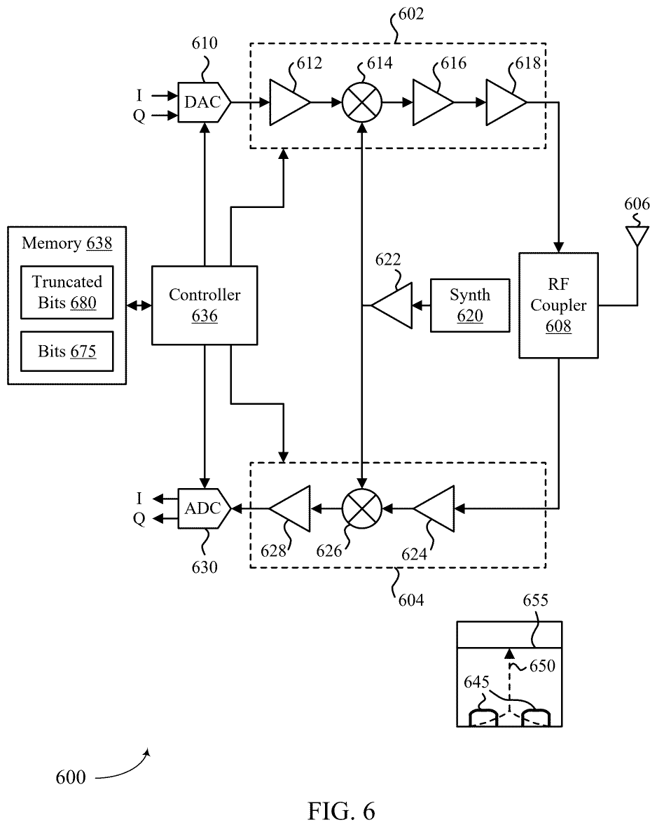

FIG. 6 shows a block diagram of an example of an RF transceiver circuit 600 that supports power control schemes for reader devices in accordance with one or more aspects of the present disclosure. The RF transceiver circuit 600 may include at least one transmit path 602 (e.g., a “transmit chain”) for transmitting signals via one or more antennas 606 and at least one receive path 604 (e.g., a “receive chain”) for receiving signals via the antenna(s) 606. When the transmit path 602 and the receive path 604 share an antenna 606, the paths may be connected with the antenna via an RF coupler 608, which may include one or more RF devices, such as one or more switches, duplexers, diplexers, or multiplexers, among other examples.

Receiving in-phase (I) or quadrature (Q) baseband analog signals from a DAC 610, the transmit path 602 may include a baseband filter (BBF) 612, a mixer 614, a driver amplifier (DA) 616, and a power amplifier 618. The BBF 612, the mixer 614, the DA 616, and the power amplifier 618 may be included in one or more radio frequency integrated circuits (RFICs). The power amplifier 618 may be external to the RFIC(s) for some implementations.

The BBF 612 may filter the baseband signals received from the DAC 610, and the mixer 614 may mix the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies may be referred to as the beat frequencies. The beat frequencies may be in the RF range, such that the signals output by the mixer 614 may be RF signals, which may be amplified by the DA 616 or by the power amplifier 618 before transmission by the antenna 606. While one mixer 614 is illustrated, one or more mixers may be used to upconvert the filtered baseband signals to one or more intermediate frequencies and to thereafter upconvert the intermediate frequency signals to a frequency for transmission.

The receive path 604 may include a low noise amplifier (LNA) 624, a mixer 626, and a baseband filter (BBF) 628. The LNA 624, the mixer 626, and the BBF 628 may be included in a RFIC, which may or may not be the same RFIC that includes the transmit path components. RF signals received via the antenna 606 may be amplified by the LNA 624, and the mixer 626 mixes the amplified RF signals with a receive local oscillator (LO) signal to convert the RF signal of interest to a different baseband frequency (e.g., downconvert). In some examples, the receive path 604 may be a feedback receive path (e.g., an RFID receiver) with a gain lineup (e.g., a first gain (G0), a second gain (G1), or a third gain (G2), among other examples). The baseband signals output by the mixer 626 may be filtered by the BBF 628 before being converted by an analog-to-digital converter (ADC) 630 to digital I or Q signals for digital signal processing. While one mixer 626 is illustrated, several mixers may be used to downconvert the amplified RF signals to one or more intermediate frequencies and to thereafter downconvert the intermediate frequency signals to baseband.

Some transceivers may employ frequency synthesizers with a voltage-controlled oscillator (VCO) to generate a stable, tunable LO with a particular tuning range. Thus, the transmit LO may be produced by a frequency synthesizer 620, which may be buffered or amplified by amplifier 622 before being mixed with the baseband signals in the mixer 614. Similarly, the receive LO may be produced by the synthesizer 620, which may be buffered or amplified by amplifier 622 before being mixed with the RF signals in the mixer 626. In the example of FIG. 6, the synthesizer 620 may provide a shared LO that may be amplified by the amplifier 622 and provided to the mixer 614 and the mixer 626. Sharing the synthesizer (e.g., LO) may enable phase noise cancelation.

A controller 636 may direct the operation of the RF transceiver circuit 600, such as transmitting signals via the transmit path 602 or receiving signals via the receive path 604. The controller 636 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 638 may store data and program codes for operating the RF transceiver circuit 600. The controller 636 or memory 638 may include control logic. In some examples, the controller 636 may determine a transmission power level (e.g., certain levels of gain at the power amplifier 618) as described herein.

In the example of FIG. 6, the memory 638 may include bits 675 and truncated bits 680. In some approaches, the controller 636 may perform bit truncation in accordance with one or more of the techniques described herein. In an example, the bits 675 may include 16 bits of I+jQ samples (e.g., 0000110101100100) from the ADC 630. The controller may truncate the 16 bits to produce 8 bits of I+jQ truncated samples. In an auto truncation example, 0000110101100100 may be truncated to 11010110 bits for subsequent processing, where the upper four MSBs (0000) and the lower four LSBs (0100) are truncated. In accordance with some of the techniques described herein, the controller 636 may perform automatic gain control (e.g., coarse automatic gain control) using a truncation bit detection mechanism or procedure.

In some examples, a feedback receiver gain state may be controlled with a gain or noise figure setting. The feedback receiver gain state may be selected based on a bit truncation of a previous packet. If relatively larger quantities of MSBs are being truncated, the feedback receiver gain state may be transitioned to a higher gain (e.g., lower noise figure) to increase sensitivity. If no MSB truncation is occurring (e.g., if 8 LSB truncation is occurring), the feedback receiver gain state may be transitioned to a lower gain (e.g., higher noise figure) to help avoid ADC saturation. For example, saturation 655 may be detected via bit truncation, where a relatively strong self-transmit leakage 650 can saturate the receiver. Additionally, or alternatively, to measure an RFID signal 645, a lower noise figure (e.g., higher gain) may be utilized to improve data rates.

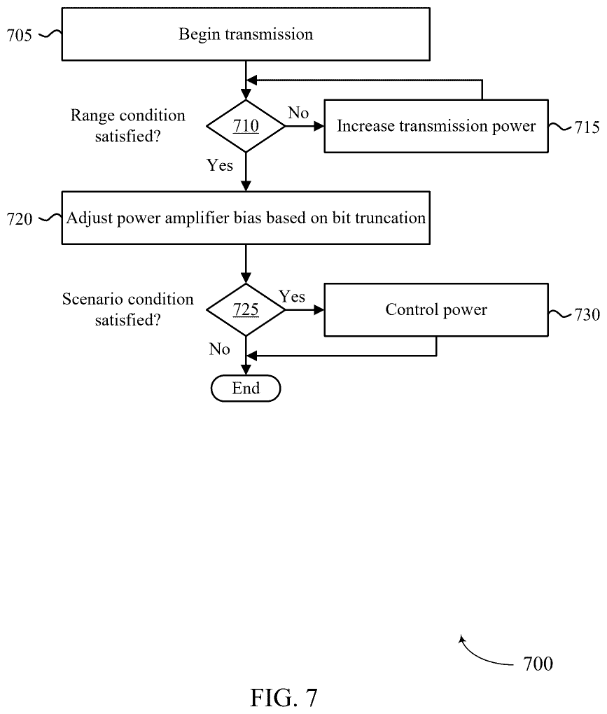

FIG. 7 shows a flowchart illustrating an example of a method 700 that supports power control schemes for reader devices in accordance with one or more aspects of the present disclosure. The operations of the method 700 may be implemented by a reader device or its components as described herein. For example, the operations of the method 700 may be performed by a reader device as described with reference to one or more of FIGS. 2-6. In some examples, a reader device may execute a set of instructions to control the functional elements of the reader device to perform the described functions. Additionally, or alternatively, the reader device may perform aspects of the described functions using special-purpose hardware.

In some examples, one or more operations of the method 700 may be omitted, or one or more operations may be added to the method 700. For instance, one or more of the operations described herein may be combined with the method 700. Additionally, or alternatively, one or more of the operations described in the method 700 may be performed in the order shown, or in a different order. In some aspects, multiple operations of the method 700 may be performed in overlapping time frames (e.g., may be combed or performed in parallel). Additionally, or alternatively, one or more of the operations of the method 700 may be divided into multiple operations.

At 705, the method may include beginning a transmission. For instance, a reader device (e.g., smartphone) may activate RFID reader mode based on a received interface (e.g., user interface) input, a received signal, or another triggering event and begin transmitting a signal (e.g., one or more packets). In some examples, the reader device (e.g., RFID reader) may start RFID starts transmission at a relatively low transmit power corresponding to a lower range and with lower power consumption.

At 710, the method may include determining whether a range condition is satisfied. For instance, the reader device may determine whether a range of the transmission has satisfied a range condition (e.g., a range threshold or a condition for dynamic range, among other examples).

The method may include increasing a transmit power at 715 if the range condition is not satisfied. One or more operations may be repeated until the range condition is satisfied. For instance, a transmission may begin at a relatively low transmit power and may ramp up power until the range condition is satisfied (e.g., until sufficient range is achieved).

The method may include adjusting a power amplifier bias based on bit truncation at 720 if the range condition is satisfied. In some approaches, the bit truncation may be utilized as an indicator of transmit power. For a relatively lower power, for instance, MSB truncation may be performed to remove one or more 0s (e.g., 0s in the upper or MSB portion of an ADC output, for instance). For a relatively higher power, one or more upper bits may have a value of 1 (e.g., MSB=1), and one or more bits in a lower portion (e.g., LSB portion of an ADC output) may be truncated (e.g., 8 LSBs may be truncated). Accordingly, the bit truncation may be an indicator (e.g., coarse indicator) of transmit power. In some approaches, the power amplifier bias adjustment may be based on the bit truncation (e.g., where MSB truncation may indicate lower power and LSB truncation may indicate higher power).

At 725, the method may include determining whether a scenario condition is satisfied. Examples of the scenario condition may include operation of a broadcast mode or a threshold distance or signal power. For instance, the reader device may determine the reader device is relatively far away from a tag device (e.g., based on received signals below a threshold) or is in broadcast mode.

At 730, the method may include controlling power if the scenario condition is satisfied. For instance, the reader device may utilize a maximum or relatively high transmit power (e.g., may increase a power amplifier bias) if the scenario condition is satisfied. When a scenario condition is satisfied, dynamic range criteria may not be as stringent, or the reader device may have improved sensitivity to a backscattered signal from a tag device. Method operation may end if the scenario condition is not satisfied or after controlling power if the scenario condition is satisfied.

In other approaches, a reader device (e.g., an RFID reader) may generally utilize a static power (e.g., an RFID reader may generally or always transmit at a maximum transmission power). The reader device may drop an LSB at a feedback receiver and may demand a relatively high dynamic range to measure a weak backscattered receive signal in the presence of a strong transmit signal. Power consumption of the reader device may be generally relatively high, as the reader device may generally transmit at a static (e.g., maximum) power for the reader device, and dynamic range requirements of a feedback receiver may be relatively stringent.

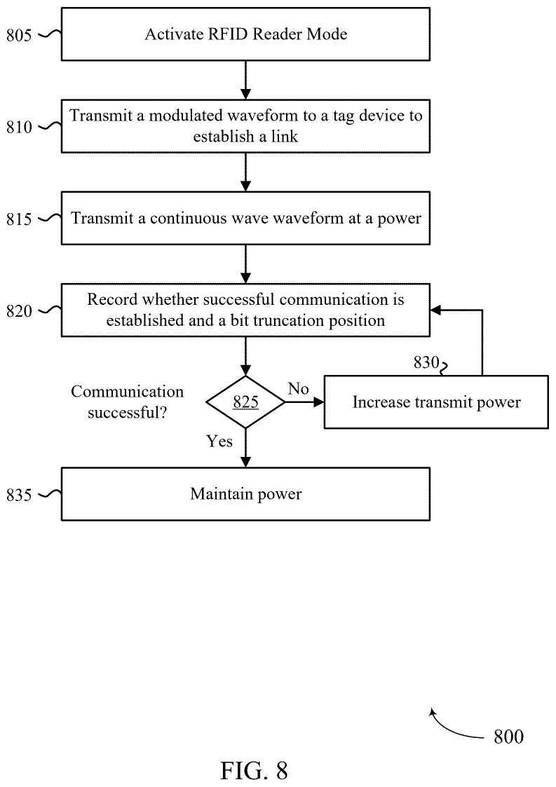

FIG. 8 shows a flowchart illustrating an example of a method 800 that supports power control schemes for reader devices in accordance with one or more aspects of the present disclosure. The operations of the method 800 may be implemented by a reader device or its components as described herein. For example, the operations of the method 800 may be performed by a reader device as described with reference to one or more of FIGS. 2-7. In some examples, a reader device may execute a set of instructions to control the functional elements of the reader device to perform the described functions. Additionally, or alternatively, the reader device may perform aspects of the described functions using special-purpose hardware.

In some examples, one or more operations of the method 800 may be omitted, or one or more operations may be added to the method 800. For instance, one or more of the operations described herein may be combined with the method 800. Additionally, or alternatively, one or more of the operations described in the method 800 may be performed in the order shown, or in a different order. In some aspects, multiple operations of the method 800 may be performed in overlapping time frames (e.g., may be combed or performed in parallel). Additionally, or alternatively, one or more of the operations of the method 800 may be divided into multiple operations.

At 805, the method may include activating an RFID reader mode. For instance, a reader device (e.g., smartphone) may activate RFID reader mode based on a received interface (e.g., user interface) input, a received signal, or another triggering event.

At 810, the method may include transmitting a modulated waveform to a tag device to establish a link. For instance, the reader device may query a specific tag device to establish link using an ASK modulated waveform.

At 815, the method may include transmitting a continuous wave waveform at a power (e.g., median power). For instance, the reader device may transition to a tag response mode and transmit a continuous wave tone at a median power corresponding to a median reader-tag distance.

At 820, the method may include recording (e.g., storing an indication of) whether successful communication is established and a bit truncation position. For instance, using feedback receiver captures, the reader device may record an indication of whether successful communication is established with tag at median power, or may record a position of bit truncation being performed as a marker of a current transmit power level. In some examples, the reader device may determine whether successful communication is established based on a received signal (e.g., a backscattered signal) from the tag device. For instance, if the reader device successfully decodes a received signal or receives a backscattered signal with a threshold signal strength, the reader device may determine that successful communication is established. If the reader device is unable to successfully decode a received signal or if a received signal has less than a threshold signal strength, the communication may not have been established successfully.

At 825, the method may include determining whether communication was successfully established. For instance, the reader device may read the record (e.g., memory) to determine whether communication was successfully established at a current transmit power. At 830, the method may include increasing transmit power if communication was not successfully established.

At 835, the method may include maintaining power if communication was successfully established. For instance, the reader device may stop increasing transmit power or may map a current truncation bit value to a transmit power or tag-reader distance (e.g., store a mapping between a current truncation bit value to a transmit power or tag-reader distance when communication was successful). The reader device may remain at the power level (e.g., backed off from maximum power) for static conditions for the tag-reader exchange.

In other approaches, a reader device (e.g., an RFID reader or smartphone) may enter a reader mode (e.g., RFID reader mode). The reader device may transmit a query to a tag device (e.g., a specific tag) to establish a link using an ASK modulated waveform. The reader device may transition to a tag response mode and transmit a continuous wave tone at a power (e.g., maximum power or highest power amplifier bias point with maximum battery loading). The reader device may remain at that power level (e.g., highest transmit power level and power amplifier bias) for the duration of the link irrespective of tag-reader distance.

Some examples of the techniques described herein may help to address power control for achieving sufficient range, which may depend on the distance between the reader device and tag device. Additionally, or alternatively, some examples of the techniques may enable increased accuracy in biasing a DAC or power amplifier in interrogator mode to ensure an improved tradeoff between emissions and power consumption, which may help to improve performance of operating at a high power to satisfy a spectral emission mask.

Some examples of the techniques described herein may enable a significant reduction in power consumption (e.g., battery power consumption for smartphone-based RFID readers). A power amplifier may significantly contribute to overall power consumption in an RF chain. Reducing the power amplifier bias point or limiting maximum transmit power while providing reader-tag links may improve overall battery life. For industrial use cases where the links may be established with a large number of tag devices from a single reader device (e.g., smartphone), the power saving features described herein may help promote usability and customer satisfaction.

Some examples of the techniques described herein may be implemented in smartphone-integrated RFID readers. Some approaches may allow integration without adding a large quantity of additional components or consuming device (e.g., integrated circuit) area. Some examples may provide an ability to leverage other connectivity and cellular wireless platforms within the smartphone for global usage and synchronization with the cloud. Some examples of use cases may include RFID interrogation using a smartphone in warehouses for inventory control, or RFID use for controlling lights, fans, or other smart home devices using a smartphone.

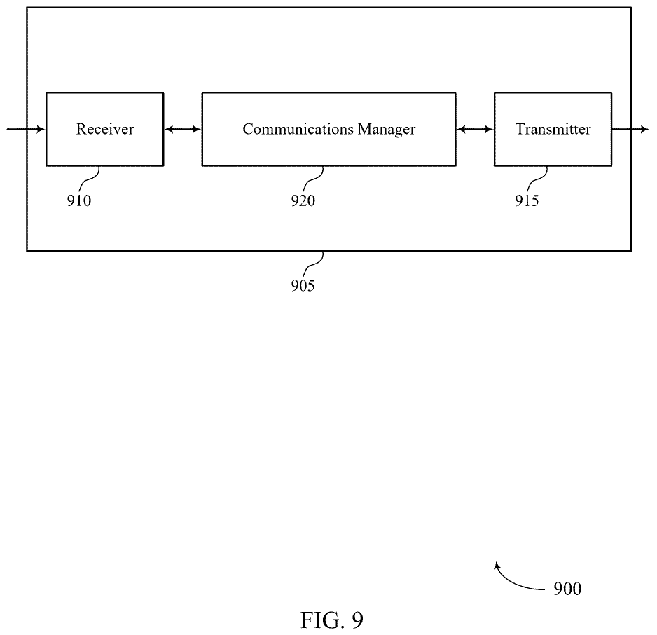

FIG. 9 shows a block diagram 900 of a device 905 that supports power control schemes for reader devices in accordance with one or more aspects of the present disclosure. The device 905 may be an example of aspects of a reader device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to power control schemes for reader devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to power control schemes for reader devices). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of power control schemes for reader devices as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for transmitting a first signal during a tag response mode, where the reader device operates, during the tag response mode, in accordance with a first power control scheme that is associated with a first bias and a first compression. The communications manager 920 is capable of, configured to, or operable to support a means for transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme. In some approaches, the second power control scheme may satisfy a spectral emission mask or the first power control scheme may not be limited by the spectral emission mask (e.g., any spectral emission mask).

For example, the communications manager 920 is capable of, configured to, or operable to support a means for transmitting a first signal at a power level, where the first signal is based on a first packet, and where bits corresponding to the first packet are truncated with a first truncation. The communications manager 920 is capable of, configured to, or operable to support a means for determining whether a communication that is associated with the first signal having the first truncation is successful. The communications manager 920 is capable of, configured to, or operable to support a means for controlling the power level based on the determination, where the power level is increased for a second packet based on an unsuccessful communication or the power level is maintained for a second packet having the first truncation based on a successful communication.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

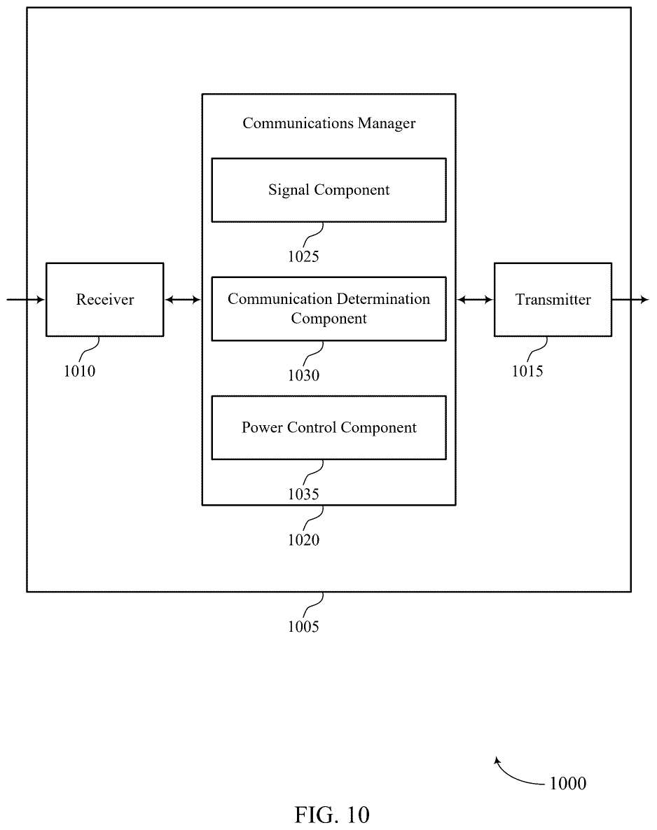

FIG. 10 shows a block diagram 1000 of a device 1005 that supports power control schemes for reader devices in accordance with one or more aspects of the present disclosure. The device 1005 may be an example of aspects of a device 905 or a reader device as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to power control schemes for reader devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to power control schemes for reader devices). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of power control schemes for reader devices as described herein. For example, the communications manager 1020 may include a signal component 1025, a communication determination component 1030, a power control component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The signal component 1025 is capable of, configured to, or operable to support a means for transmitting a first signal during a tag response mode, where the reader device operates, during the tag response mode, in accordance with a first power control scheme that is associated with a first bias and a first compression. The signal component 1025 is capable of, configured to, or operable to support a means for transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme. In some approaches, the second power control scheme may satisfy a spectral emission mask or the first power control scheme may not be limited by the spectral emission mask (e.g., any spectral emission mask).

The signal component 1025 is capable of, configured to, or operable to support a means for transmitting a first signal at a power level, where the first signal is based on a first packet, and where bits corresponding to the first packet are truncated with a first truncation. The communication determination component 1030 is capable of, configured to, or operable to support a means for determining whether a communication that is associated with the first signal having the first truncation is successful. The power control component 1035 is capable of, configured to, or operable to support a means for controlling the power level based on the determination, where the power level is increased for a second packet based on an unsuccessful communication or the power level is maintained for a second packet having the first truncation based on a successful communication.

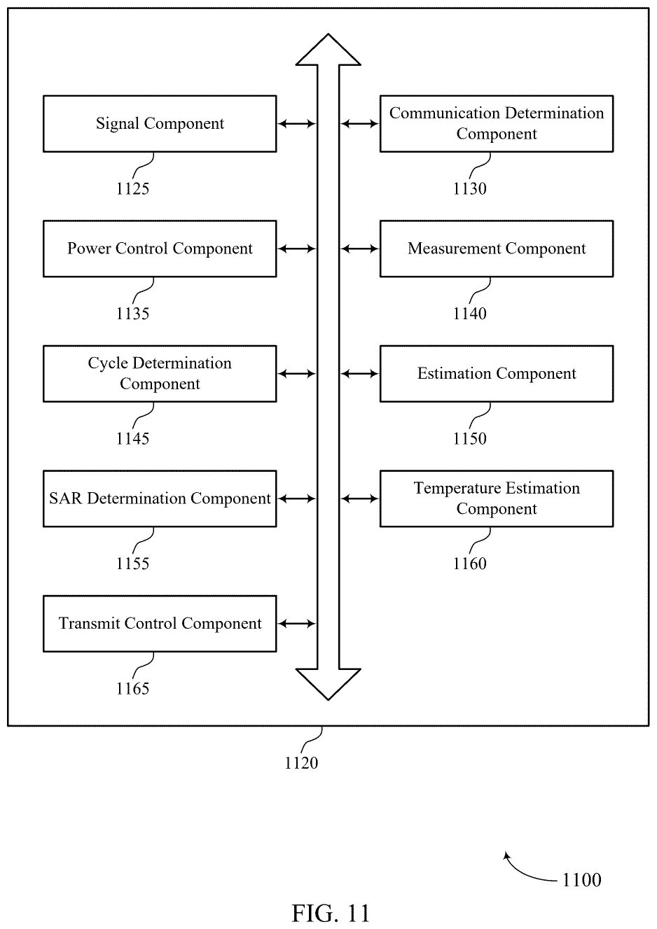

FIG. 11 shows a block diagram 1100 of a communications manager 1120 that supports power control schemes for reader devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of power control schemes for reader devices as described herein. For example, the communications manager 1120 may include a signal component 1125, a communication determination component 1130, a power control component 1135, a measurement component 1140, a cycle determination component 1145, an estimation component 1150, an SAR determination component 1155, a temperature estimation component 1160, a transmit control component 1165, or any combination thereof. Each of these components, or components or subcomponents thereof (e.g., one or more processors, one or more memories), may communicate, directly or indirectly, with one another (e.g., via one or more buses).

The signal component 1125 is capable of, configured to, or operable to support a means for transmitting a first signal during a tag response mode, where the reader device operates, during the tag response mode, in accordance with a first power control scheme that is associated with a first bias and a first compression. In some examples, the signal component 1125 is capable of, configured to, or operable to support a means for transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme. In some approaches, the second power control scheme may satisfy a spectral emission mask or the first power control scheme may not be limited by the spectral emission mask (e.g., any spectral emission mask).

In some examples, the first power control scheme includes supplying a first voltage in accordance with the first bias that is less than a voltage supplied in accordance with the second bias for the second power control scheme.

In some examples, the first signal during the tag response mode is a continuous wave signal.

In some examples, the second signal communicated during the interrogator mode is a modulated signal.

In some examples, during the interrogator mode, the reader device generates the second signal based on the second bias. In some examples, the second signal satisfies, within a tolerance, a set of one or more power or emission limits that varies over a spectral range including a center frequency of the second signal (e.g., a spectral emission mask that includes a set of one or more power or emission limits that varies over a spectral range including a center frequency).

In some examples, the measurement component 1140 is capable of, configured to, or operable to support a means for measuring digital samples associated with the second signal before power amplification and transmission, where the second bias is selected based on the measurement of the digital samples for the second signal to satisfy, within a tolerance, a set of one or more power or emission limits that varies over a spectral range including a center frequency (e.g., a spectral emission mask that includes a set of one or more power or emission limits that varies over a spectral range including a center frequency).

In some examples, the measurement component 1140 is capable of, configured to, or operable to support a means for measuring the second signal via a feedback receiver, where the second bias is selected based on the measurement of the second signal for a transmission to satisfy, within a tolerance, a power limit that varies over a spectral range including a center frequency (e.g., a spectral emission mask that includes a set of one or more power or emission limits that varies over a spectral range including a center frequency).

In some examples, the signal component 1125 is capable of, configured to, or operable to support a means for transmitting a first signal at a power level, where the first signal is based on a first packet, and where bits corresponding to the first packet are truncated with a first truncation. The communication determination component 1130 is capable of, configured to, or operable to support a means for determining whether a communication that is associated with the first signal having the first truncation is successful. The power control component 1135 is capable of, configured to, or operable to support a means for controlling the power level based on the determination, where the power level is increased for a second packet based on an unsuccessful communication or the power level is maintained for a second packet having the first truncation based on a successful communication.

In some examples, controlling the power level includes setting the power level to a first level for a MSB truncation, setting the power level to a second level for a least significant bit (LSB) truncation, or setting the power level to a third level for LSB truncation and MSB truncation.

In some examples, the power level is controlled by a feedback receiver based on a feedback signal that is based on the first signal.

In some examples, the measurement component 1140 is capable of, configured to, or operable to support a means for measuring digital samples associated with the first signal before power amplification and transmission, where the power level is controlled by a feedback receiver based on the measurement of the digital samples for the first signal to satisfy, within a tolerance, a set of one or more power or emission limits that varies over a spectral range including a center frequency (e.g., a spectral emission mask that includes a set of one or more power or emission limits that varies over a spectral range including a center frequency).

In some examples, the power control component 1135 is capable of, configured to, or operable to support a means for adjusting a starting power level for controlling the power level based on whether the communication was successful.

In some examples, the signal component 1125 is capable of, configured to, or operable to support a means for transmitting a second signal during an interrogator mode, where the power level is controlled based on the starting power level determined for a tag response mode.

In some examples, the cycle determination component 1145 is capable of, configured to, or operable to support a means for determining an average power of a duty cycle of the reader device based on a statistic that is based on the first truncation. In some examples, the estimation component 1150 is capable of, configured to, or operable to support a means for estimating a thermal condition or usage based on the average power.

In some examples, the cycle determination component 1145 is capable of, configured to, or operable to support a means for determining an average power of a duty cycle of the reader device based on a statistic that is based on the first truncation. In some examples, the power control component 1135 is capable of, configured to, or operable to support a means for controlling the power level of the reader device for a period in which the reader device communicates via another RAT based on the average power.

In some examples, the SAR determination component 1155 is capable of, configured to, or operable to support a means for determining a SAR value based on the power level (e.g., the power level that may be estimated based on bit truncation), where the SAR value indicates a peak SAR or an average SAR.

In some examples, the SAR determination component 1155 is capable of, configured to, or operable to support a means for obtaining one or more SAR values corresponding to one or more RATs. In some examples, the transmit control component 1165 is capable of, configured to, or operable to support a means for controlling transmit activity based on a combination of the SAR value and the one or more SAR values corresponding to the one or more RATs.

In some examples, the temperature estimation component 1160 is capable of, configured to, or operable to support a means for determining an estimate of temperature associated with the reader device based on the power level (e.g., that may be estimated based on bit truncation). In some examples, the power control component 1135 is capable of, configured to, or operable to support a means for controlling a first bias power of a power amplifier for a continuous wave transmission. In some examples, the power control component 1135 is capable of, configured to, or operable to support a means for controlling a second bias power of the power amplifier for a modulated wave transmission based on the estimate of temperature and the bit truncation.

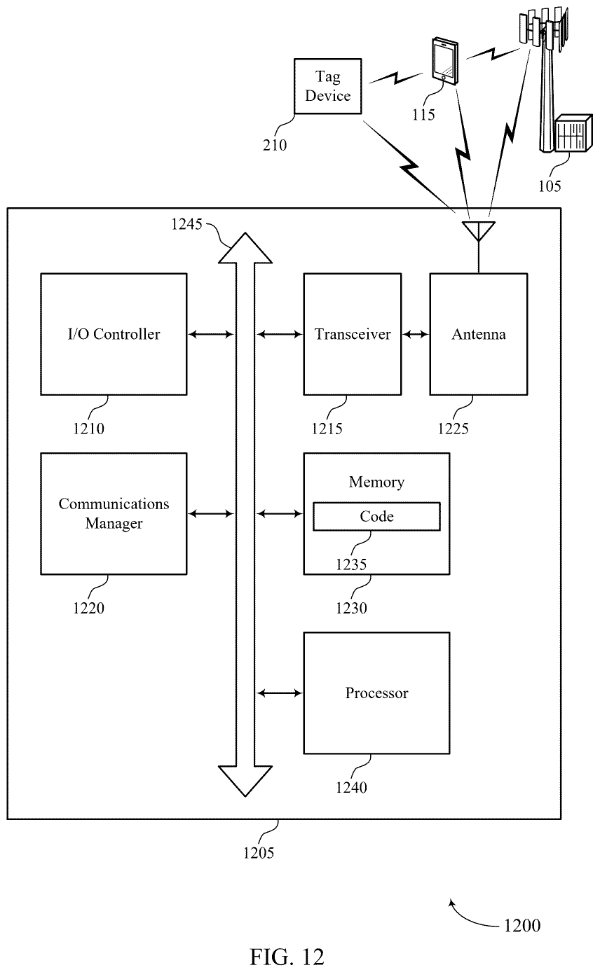

FIG. 12 shows a diagram of a system 1200 including a device 1205 that supports power control schemes for reader devices in accordance with one or more aspects of the present disclosure. The device 1205 may be an example of or include components of a device 905, a device 1005, or a reader device as described herein. The device 1205 may include components for bi-directional voice and data communications including components for transmitting and receiving communications, such as a communications manager 1220, an I/O controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting power control schemes for reader devices). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

For example, the communications manager 1220 is capable of, configured to, or operable to support a means for transmitting a first signal during a tag response mode, where the reader device operates, during the tag response mode, in accordance with a first power control scheme that is associated with a first bias and a first compression. The communications manager 1220 is capable of, configured to, or operable to support a means for transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme. In some approaches, the second power control scheme may satisfy a spectral emission mask or the first power control scheme may not be limited by the spectral emission mask (e.g., any spectral emission mask).

For example, the communications manager 1220 is capable of, configured to, or operable to support a means for transmitting a first signal at a power level, where the first signal is based on a first packet, and where bits corresponding to the first packet are truncated with a first truncation. The communications manager 1220 is capable of, configured to, or operable to support a means for determining whether a communication that is associated with the first signal having the first truncation is successful. The communications manager 1220 is capable of, configured to, or operable to support a means for controlling the power level based on the determination, where the power level is increased for a second packet based on an unsuccessful communication or the power level is maintained for a second packet having the first truncation based on a successful communication.

By including or configuring the communications manager 1220 in accordance with examples as described herein, the device 1205 may support techniques for improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of power control schemes for reader devices as described herein, or the at least one processor 1240 and the at least one memory 1230 may be otherwise configured to, individually or collectively, perform or support such operations.

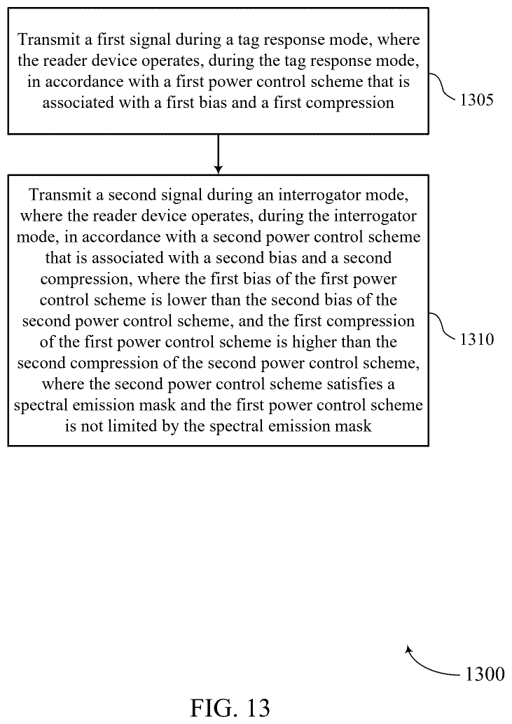

FIG. 13 shows a flowchart illustrating a method 1300 that supports power control schemes for reader devices in accordance with one or more aspects of the present disclosure. The operations of the method 1300 may be implemented by a reader device or its components as described herein. For example, the operations of the method 1300 may be performed by a reader device as described with reference to FIGS. 1 through 12. In some examples, a reader device may execute a set of instructions to control the functional elements of the reader device to perform the described functions. Additionally, or alternatively, the reader device may perform aspects of the described functions using special-purpose hardware.

At 1305, the method may include transmitting a first signal during a tag response mode, where the reader device operates, during the tag response mode, in accordance with a first power control scheme that is associated with a first bias and a first compression. The operations of 1305 may be performed in accordance with examples as disclosed herein. In some examples, aspects of the operations of 1305 may be performed by a signal component 1125 as described with reference to FIG. 11.

At 1310, the method may include transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second power control scheme satisfies a spectral emission mask and the first power control scheme is not limited by the spectral emission mask. The operations of 1310 may be performed in accordance with examples as disclosed herein. In some examples, aspects of the operations of 1310 may be performed by a signal component 1125 as described with reference to FIG. 11.

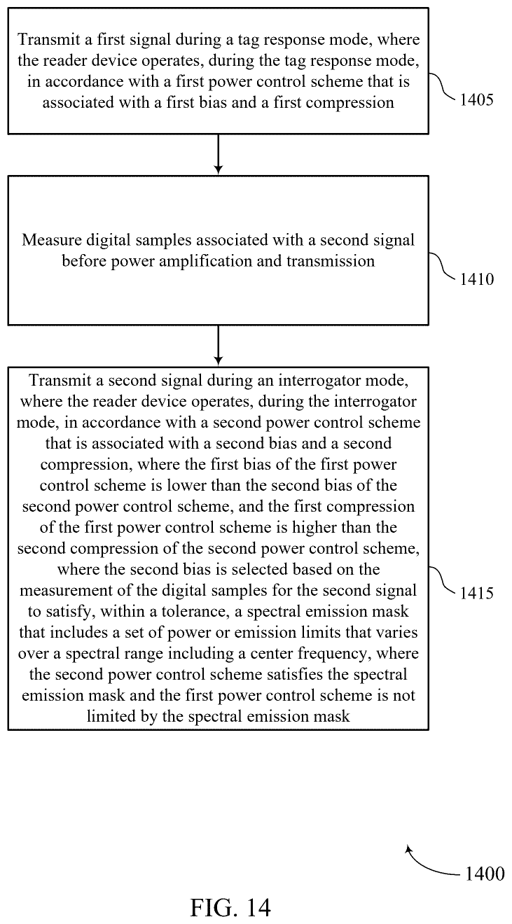

FIG. 14 shows a flowchart illustrating a method 1400 that supports power control schemes for reader devices in accordance with one or more aspects of the present disclosure. The operations of the method 1400 may be implemented by a reader device or its components as described herein. For example, the operations of the method 1400 may be performed by a reader device as described with reference to FIGS. 1 through 12. In some examples, a reader device may execute a set of instructions to control the functional elements of the reader device to perform the described functions. Additionally, or alternatively, the reader device may perform aspects of the described functions using special-purpose hardware.

At 1405, the method may include transmitting a first signal during a tag response mode, where the reader device operates, during the tag response mode, in accordance with a first power control scheme that is associated with a first bias and a first compression. The operations of 1405 may be performed in accordance with examples as disclosed herein. In some examples, aspects of the operations of 1405 may be performed by a signal component 1125 as described with reference to FIG. 11.

At 1410, the method may include measuring digital samples associated with the second signal before power amplification and transmission. The operations of 1410 may be performed in accordance with examples as disclosed herein. In some examples, aspects of the operations of 1410 may be performed by a measurement component 1140 as described with reference to FIG. 11.

At 1415, the method may include transmitting a second signal during an interrogator mode, where the reader device operates, during the interrogator mode, in accordance with a second power control scheme that is associated with a second bias and a second compression, where the first bias of the first power control scheme is lower than the second bias of the second power control scheme, and the first compression of the first power control scheme is higher than the second compression of the second power control scheme, where the second bias is selected based on the measurement of the digital samples for the second signal to satisfy, within a tolerance, a set of one or more power or emission limits that varies over a spectral range including a center frequency (e.g., a spectral emission mask that includes a set of one or more power or emission limits that varies over a spectral range including a center frequency), where the second power control scheme satisfies the spectral emission mask and the first power control scheme is not limited by the spectral emission mask. The operations of 1415 may be performed in accordance with examples as disclosed herein. In some examples, aspects of the operations of 1415 may be performed by a signal component 1125 as described with reference to FIG. 11.

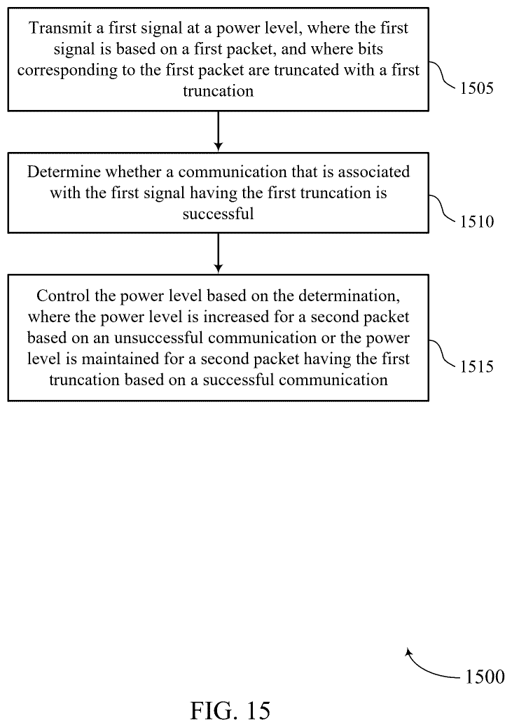

FIG. 15 shows a flowchart illustrating a method 1500 that supports power control schemes for reader devices in accordance with one or more aspects of the present disclosure. The operations of the method 1500 may be implemented by a reader device or its components as described herein. For example, the operations of the method 1500 may be performed by a reader device as described with reference to FIGS. 1 through 12. In some examples, a reader device may execute a set of instructions to control the functional elements of the reader device to perform the described functions. Additionally, or alternatively, the reader device may perform aspects of the described functions using special-purpose hardware.

At 1505, the method may include transmitting a first signal at a power level, where the first signal is based on a first packet, and where bits corresponding to the first packet are truncated with a first truncation. The operations of 1505 may be performed in accordance with examples as disclosed herein. In some examples, aspects of the operations of 1505 may be performed by a signal component 1125 as described with reference to FIG. 11.

At 1510, the method may include determining whether a communication that is associated with the first signal having the first truncation is successful. The operations of 1510 may be performed in accordance with examples as disclosed herein. In some examples, aspects of the operations of 1510 may be performed by a communication determination component 1130 as described with reference to FIG. 11.

At 1515, the method may include controlling the power level based on the determination, where the power level is increased for a second packet based on an unsuccessful communication or the power level is maintained for a second packet having the first truncation based on a successful communication. The operations of 1515 may be performed in accordance with examples as disclosed herein. In some examples, aspects of the operations of 1515 may be performed by a power control component 1135 as described with reference to FIG. 11.

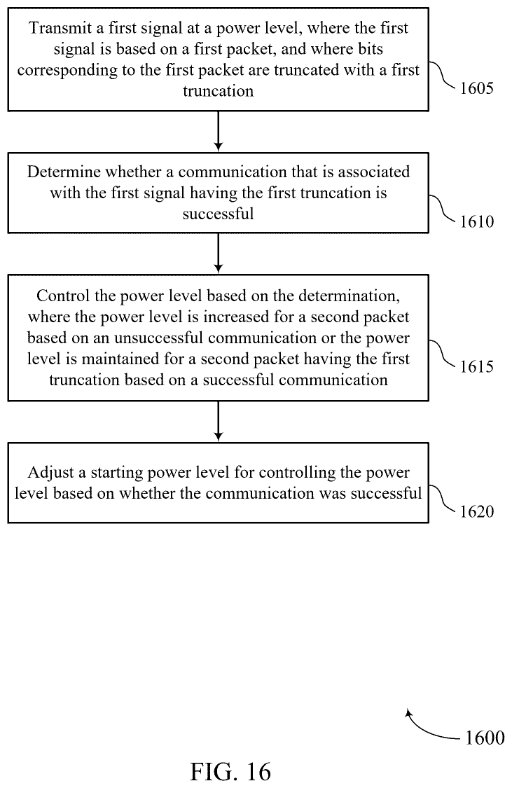

FIG. 16 shows a flowchart illustrating a method 1600 that supports power control schemes for reader devices in accordance with one or more aspects of the present disclosure. The operations of the method 1600 may be implemented by a reader device or its components as described herein. For example, the operations of the method 1600 may be performed by a reader device as described with reference to FIGS. 1 through 12. In some examples, a reader device may execute a set of instructions to control the functional elements of the reader device to perform the described functions. Additionally, or alternatively, the reader device may perform aspects of the described functions using special-purpose hardware.

At 1605, the method may include transmitting a first signal at a power level, where the first signal is based on a first packet, and where bits corresponding to the first packet are truncated with a first truncation. The operations of 1605 may be performed in accordance with examples as disclosed herein. In some examples, aspects of the operations of 1605 may be performed by a signal component 1125 as described with reference to FIG. 11.

At 1610, the method may include determining whether a communication that is associated with the first signal having the first truncation is successful. The operations of 1610 may be performed in accordance with examples as disclosed herein. In some examples, aspects of the operations of 1610 may be performed by a communication determination component 1130 as described with reference to FIG. 11.

At 1615, the method may include controlling the power level based on the determination, where the power level is increased for a second packet based on an unsuccessful communication or the power level is maintained for a second packet having the first truncation based on a successful communication. The operations of 1615 may be performed in accordance with examples as disclosed herein. In some examples, aspects of the operations of 1615 may be performed by a power control component 1135 as described with reference to FIG. 11.

At 1620, the method may include adjusting a starting power level for controlling the power level based on whether the communication was successful. The operations of 1620 may be performed in accordance with examples as disclosed herein. In some examples, aspects of the operations of 1620 may be performed by a power control component 1135 as described with reference to FIG. 11.

The following provides an overview of aspects of the present disclosure:

Aspect 1: A method for wireless communications by a reader device, comprising: transmitting a first signal during a tag response mode, wherein the reader device operates, during the tag response mode, in accordance with a first power control scheme that is associated with a first bias and a first compression; and transmitting a second signal during an interrogator mode, wherein the reader device operates, during the interrogator mode, in accordance with a second power control scheme that is associated with a second bias and a second compression, wherein the first bias of the first power control scheme is lower than the second bias of the second power control scheme, and the first compression of the first power control scheme is higher than the second compression of the second power control scheme, wherein the second power control scheme satisfies a spectral emission mask and the first power control scheme is not limited by the spectral emission mask.

Aspect 2: The method of aspect 1, wherein the first power control scheme comprises supplying a first voltage in accordance with the first bias that is less than a voltage supplied in accordance with the second bias for the second power control scheme.

Aspect 3: The method of any of aspects 1 through 2, wherein the first signal during the tag response mode is a continuous wave signal.

Aspect 4: The method of any of aspects 1 through 3, wherein the second signal communicated during the interrogator mode is a modulated signal.

Aspect 5: The method of any of aspects 1 through 4, wherein during the interrogator mode, the reader device generates the second signal based at least in part on the second bias, wherein the second signal satisfies, within a tolerance, the spectral emission mask that comprises a set of power or emission limits that varies over a spectral range including a center frequency of the second signal.

Aspect 6: The method of any of aspects 1 through 5, further comprising: measuring digital samples associated with the second signal before power amplification and transmission, wherein the second bias is selected based at least in part on the measurement of the digital samples for the second signal to satisfy, within a tolerance, the spectral emission mask that comprises a set of power or emission limits that varies over a spectral range including a center frequency.

Aspect 7: The method of any of aspects 1 through 4, further comprising: measuring the second signal via a feedback receiver, wherein the second bias is selected based at least in part on the measurement of the second signal for a transmission to satisfy, within a tolerance, the spectral emission mask that comprises a set of a power or emission limits that varies over a spectral range including a center frequency.

Aspect 8: A method for wireless communications by a reader device, comprising: transmitting a first signal at a power level, wherein the first signal is based at least in part on a first packet, and wherein bits corresponding to the first packet are truncated with a first truncation; determining whether a communication that is associated with the first signal having the first truncation is successful; and controlling the power level based at least in part on the determination, wherein the power level is increased for a second packet based at least in part on an unsuccessful communication or the power level is maintained for a second packet having the first truncation based at least in part on a successful communication.

Aspect 9: The method of aspect 8, wherein controlling the power level comprises setting the power level to a first level for a MSB truncation, setting the power level to a second level for a LSB truncation, or setting the power level to a third level for LSB truncation and MSB truncation.

Aspect 10: The method of any of aspects 8 through 9, wherein the power level is controlled by a feedback receiver based at least in part on a feedback signal that is based at least in part on the first signal.

Aspect 11: The method of any of aspects 8 through 9, further comprising: measuring digital samples associated with the first signal before power amplification and transmission, wherein the power level is controlled by a feedback receiver based at least in part on the measurement of the digital samples for the first signal to satisfy, within a tolerance, a set of power or emission limits that varies over a spectral range including a center frequency.

Aspect 12: The method of any of aspects 8 through 11, further comprising: adjusting a starting power level for controlling the power level based at least in part on whether the communication was successful.

Aspect 13: The method of aspect 12, further comprising: transmitting a second signal during an interrogator mode, wherein the power level is controlled based at least in part on the starting power level determined for a tag response mode.

Aspect 14: The method of any of aspects 8 through 13, further comprising: determining an average power of a duty cycle of the reader device based at least in part on a statistic that is based at least in part on the first truncation; and estimating a thermal Condition or usage based at least in part on the average power.

Aspect 15: The method of any of aspects 8 through 14, further comprising: determining an average power of a duty cycle of the reader device based at least in part on a statistic that is based at least in part on the first truncation; and controlling the power level of the reader device for a period in which the reader device communicates via another RAT based at least in part on the average power.

Aspect 16: The method of any of aspects 8 through 15, further comprising: determining a SAR value based at least in part on the power level that is based at least in part on bit truncation, wherein the SAR value indicates a peak SAR or an average SAR.

Aspect 17: The method of aspect 16, further comprising: obtaining one or more SAR values corresponding to one or more RATs; and controlling transmit activity based at least in part on a combination of the SAR value and the one or more SAR values corresponding to the one or more RATs.

Aspect 18: The method of any of aspects 8 through 17, further comprising: determining an estimate of temperature associated with the reader device based at least in part on the power level that is estimated based at least in part on bit truncation; controlling a first bias power of a power amplifier for a continuous wave transmission; and controlling a second bias power of the power amplifier for a modulated wave transmission based at least in part on the estimate of temperature and the bit truncation.

Aspect 19: A reader device comprising one or more transceivers, one or more memory, and one or more processors electronically coupled to the one or more memory and the one or transceivers, the one or more processors configured to perform a method of any of aspects 1 through 7.

Aspect 20: A reader device comprising at least one means for performing a method of any of aspects 1 through 7.

Aspect 21: A non-transitory computer-readable medium storing code the code comprising instructions executable by one or more processors to perform a method of any of aspects 1 through 7.

Aspect 22: A reader device comprising one or more transceivers, one or more memory, and one or more processors electronically coupled to the one or more memory and the one or transceivers, the one or more processors configured to perform a method of any of aspects 8 through 18.

Aspect 23: A reader device comprising at least one means for performing a method of any of aspects 8 through 18.

Aspect 24: A non-transitory computer-readable medium storing code the code comprising instructions executable by one or more processors to perform a method of any of aspects 8 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A reader device, comprising:
one or more transceivers;
one or more memory; and
one or more processors electronically coupled to the one or more memory and the one or more transceivers, the one or more processors configured to:
transmit a first signal during a tag response mode, wherein the reader device operates, during the tag response mode, in accordance with a first power control scheme that is associated with a first bias and a first compression; and
transmit a second signal during an interrogator mode, wherein the reader device operates, during the interrogator mode, in accordance with a second power control scheme that is associated with a second bias and a second compression, wherein the first bias of the first power control scheme is lower than the second bias of the second power control scheme, and the first compression of the first power control scheme is higher than the second compression of the second power control scheme, wherein the second power control scheme satisfies a spectral emission mask and the first power control scheme is not limited by the spectral emission mask.

2. The reader device of claim 1, wherein the first power control scheme comprises supplying a first voltage in accordance with the first bias that is less than a voltage supplied in accordance with the second bias for the second power control scheme.

3. The reader device of claim 1, wherein the first signal during the tag response mode is a continuous wave signal.

4. The reader device of claim 1, wherein the second signal communicated during the interrogator mode is a modulated signal.

5. The reader device of claim 1, wherein:
during the interrogator mode, the reader device generates the second signal based at least in part on the second bias, and
the second signal satisfies, within a tolerance, the spectral emission mask that comprises a set of power or emission limits that varies over a spectral range including a center frequency of the second signal.

6. The reader device of claim 1, wherein the one or more processors are configured to:
measure digital samples associated with the second signal before power amplification and transmission, wherein the second bias is selected based at least in part on the measurement of the digital samples for the second signal to satisfy, within a tolerance, the spectral emission mask that comprises a set of power or emission limits that varies over a spectral range including a center frequency.

7. The reader device of claim 1, wherein the one or more processors are configured to:
measure the second signal via a feedback receiver, wherein the second bias is selected based at least in part on the measurement of the second signal for a transmission to satisfy, within a tolerance, the spectral emission mask that comprises a set of power or emission limits that varies over a spectral range including a center frequency.

8. A reader device, comprising:
one or more transceivers;
one or more memory; and
one or more processors electronically coupled to the one or more memory and the one or more transceivers, the one or more processors configured to:
transmit a first signal at a power level, wherein the first signal is based at least in part on a first packet, and wherein bits corresponding to the first packet are truncated with a first truncation;
determine whether a communication that is associated with the first signal having the first truncation is successful; and
control the power level based at least in part on the determination, wherein the power level is increased for a second packet based at least in part on an unsuccessful communication or the power level is maintained for a second packet having the first truncation based at least in part on a successful communication.

9. The reader device of claim 8, wherein controlling the power level comprises setting the power level to a first level for a most significant bit (MSB) truncation, setting the power level to a second level for a least significant bit (LSB) truncation, or setting the power level to a third level for LSB truncation and MSB truncation.

10. The reader device of claim 8, wherein the one or more processors are configured to:
measure digital samples associated with the first signal before power amplification and transmission, wherein the power level is controlled by a feedback receiver based at least in part on the measurement of the digital samples for the first signal to satisfy, within a tolerance, a set of power or emission limits that varies over a spectral range including a center frequency; and
adjust a starting power level for controlling the power level based at least in part on whether the communication was successful.

11. The reader device of claim 10, wherein the one or more processors are configured to:
transmit a second signal during an interrogator mode, wherein the power level is controlled based at least in part on the starting power level determined for a tag response mode.

12. The reader device of claim 8, wherein the one or more processors are configured to:
determine an average power of a duty cycle of the reader device based at least in part on a statistic that is based at least in part on the first truncation; and
estimate a thermal condition or usage based at least in part on the average power.

13. The reader device of claim 8, wherein the one or more processors are configured to:
determine an average power of a duty cycle of the reader device based at least in part on a statistic that is based at least in part on the first truncation; and
control the power level of the reader device for a period in which the reader device communicates via another radio access technology (RAT) based at least in part on the average power.

14. The reader device of claim 8, wherein the one or more processors are configured to:
determine a specific absorption rate (SAR) value based at least in part on the power level that is estimated based at least in part on bit truncation, wherein the SAR value indicates a peak SAR or an average SAR.

15. The reader device of claim 14, wherein the one or more processors are configured to:
obtain one or more SAR values corresponding to one or more radio access technologies (RATs); and
control transmit activity based at least in part on a combination of the SAR value and the one or more SAR values corresponding to the one or more RATs.

16. The reader device of claim 8, wherein the one or more processors are configured to:
determine an estimate of temperature associated with the reader device based at least in part on the power level that is estimated based at least in part on bit truncation;
control a first bias power of a power amplifier for a continuous wave transmission; and
control a second bias power of the power amplifier for a modulated wave transmission based at least in part on the estimate of temperature and the bit truncation.

17. A method for wireless communications by a reader device, comprising:
transmitting a first signal during a tag response mode, wherein the reader device operates, during the tag response mode, in accordance with a first power control scheme that is associated with a first bias and a first compression; and
transmitting a second signal during an interrogator mode, wherein the reader device operates, during the interrogator mode, in accordance with a second power control scheme that is associated with a second bias and a second compression, wherein the first bias of the first power control scheme is lower than the second bias of the second power control scheme, and the first compression of the first power control scheme is higher than the second compression of the second power control scheme, wherein the second power control scheme satisfies a spectral emission mask and the first power control scheme is not limited by the spectral emission mask.

18. The method of claim 17, wherein the first power control scheme comprises supplying a first voltage in accordance with the first bias that is less than a voltage supplied in accordance with the second bias for the second power control scheme.

19. The method of claim 17, wherein the first signal during the tag response mode is a continuous wave signal.

20. The method of claim 17, wherein the second signal communicated during the interrogator mode is a modulated signal.
